(19) United States
(12) Patent Application Publication
(10) Pub. No.: US 2026/0253398 A1
(43) Pub. Date: Aug. 27, 2026

(54) SYSTEMS AND METHODS OF ENABLING MULTI-REGION OF INTEREST PROCESSING BY A MODEL AT INFERENCE-TIME

(71) Applicant: QUALCOMM Incorporated, San Diego, CA (US)

(72) Inventors: Srenivas VARADARAJAN, Bangalore (IN); Avani RAO, Bangalore (IN); Ajit Deepak GUPTE, Bangalore (IN); Titash RAKSHIT, Austin, TX (US)

(21) Appl. No.: 19/064,915

(22) Filed: Feb. 27, 2025

(51) Int. Cl. G06V 10/82; G06F 40/284; G06F 40/40; G06T 11/00; G06V 10/25; G06V 10/26; G06V 10/40; G06V 10/72; G06V 10/77; G06V 10/80; G06V 20/20; G06V 20/59; G06V 20/62; G06V 30/148; G06V 30/18

(52) U.S. Cl. CPC G06V 10/82; G06F 40/284; G06F 40/40; G06T 11/00; G06V 10/25; G06V 10/267; G06V 10/40; G06V 10/72; G06V 10/7715; G06V 10/806; G06V 20/20; G06V 20/597; G06V 20/63; G06V 30/148; G06V 30/18; G06T 2200/24

(57) ABSTRACT

A device includes a memory configured to store model data associated with a multimodal model that includes an image encoder and a large language model (LLM). The device also includes one or more processors configured to obtain image data representing an image. The one or more processors are configured to obtain data representing multiple regions of interest (ROIs) within the image, the multiple ROIs including one or more ROIs that include text. The one or more processors are configured to arrange image representations of the ROIs into a single canvas image, and to input the canvas image into the image encoder to obtain image tokens associated with cells of the canvas image. The one or more processors are configured to provide a first input to the LLM, the first input based on the image tokens, to generate a response output that corresponds to a response to a query.

### I. FIELD

The present disclosure is generally related to image processing.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

These devices may leverage machine learning (ML) models and artificial intelligence (AI) models to enable a wide variety of functionality. For example, language models can be trained on a wide corpus of information to answer questions from a user, such as how to prepare a meal, whether a particular store sells a particular product, or other questions. Additionally, multimodal models, such as large multimodal models (LMMs), combine visual scene and image processing with the functionality of language models to enhance AI systems' ability to understand a visual scene and interactions with human users. For example, a user may view image(s), video, or an extended reality display and ask a question about an object in a visual scene, and a multimodal model may provide a response to the question. Although LMMs and other models are trained to provide answers to a wide variety of questions, the LMMs may struggle to answer more specific or detailed questions related to visual scenes.

To improve the capability of an LMM to correctly answer questions about a visual scene, techniques such as visual grounding or referring can be used to enhance the LMM's understanding of the visual world. For example, a system can be configured to identify a region of interest (ROI) in a visual scene based on a user's finger pointing, eye gaze, or through the user's speech. Often, information that is needed to answer questions about a scene is present in the scene as scene-text, such as on signs, magazines, pamphlets, posters, etc., which can be localized into ROIs using text detection and encoded as additional inputs to the LMM. However, if a scene contains multiple ROIs, sequentially encoding each of the ROIs as inputs into a LMM can become computationally expensive and introduce additional latency that impacts a user experience.

### III. SUMMARY

According to one implementation of the present disclosure, a device includes a memory configured to store model data associated with a multimodal model that includes an image encoder and a large language model (LLM). The image encoder is configured to generate tokens that represent image features. The device also includes one or more processors coupled to the memory and configured to obtain image data representing an image. The one or more processors are configured to obtain data representing multiple regions of interest (ROIs) within the image, the multiple ROIs including one or more ROIs that include text. The one or more processors are configured to arrange image representations of the ROIs into a single canvas image. The one or more processors are configured to input the canvas image into the image encoder to obtain image tokens associated with cells of the canvas image. The one or more processors are configured to provide a first input to the LLM, the first input based on the image tokens, to generate a response output that corresponds to a response to a query.

According to another implementation of the present disclosure, a method includes obtaining image data representing an image. The method also includes obtaining data representing multiple regions of interest (ROIs) within the image, the multiple ROIs including one or more ROIs that include text. The method also includes arranging image representations of the ROIs into a single canvas image. The method also includes inputting the canvas image into an image encoder of a multimodal model to obtain image tokens associated with cells of the canvas image. The method also includes providing a first input to a large language model (LLM) of the multimodal model, the first input based on the image tokens, to generate a response output.

According to another implementation of the present disclosure, a non-transitory computer readable storage medium stores instructions that, when executed by one or more processors, cause the one or more processors to obtain image data representing an image. The instructions, when executed by one or more processors, cause the one or more processors to obtain data representing multiple regions of interest (ROIs) within the image, the multiple ROIs including one or more ROIs that include text. The instructions, when executed by one or more processors, cause the one or more processors to arrange image representations of the ROIs into a single canvas image. The instructions, when executed by one or more processors, cause the one or more processors to input the canvas image into an image encoder of a multimodal model to obtain image tokens associated with cells of the canvas image. The instructions, when executed by one or more processors, cause the one or more processors to provide a first input to a large language model (LLM) of the multimodal model, the first input based on the image tokens, to generate a response output.

According to another implementation of the present disclosure, an apparatus includes means for obtaining image data representing an image. The apparatus further includes means for obtaining data representing multiple regions of interest (ROIs) within the image, the multiple ROIs including one or more ROIs that include text. The apparatus further includes means for arranging image representations of the ROIs into a single canvas image. The apparatus further includes means for inputting the canvas image into an image encoder of a multimodal model to obtain image tokens associated with cells of the canvas image. The apparatus further includes means for providing a first input to a large language model (LLM) of the multimodal model, the first input based on the image tokens, to generate a response output.

According to another implementation of the present disclosure, a device includes a memory configured to store model data associated with a multimodal model that includes an image encoder and a large language model (LLM). The device also includes one or more processors coupled to the memory and configured to obtain image data representing an image. The one or more processors are configured to obtain data representing multiple regions of interest (ROIs) within the image. The one or more processors are configured to arrange image representations of the multiple ROIs into a single canvas image with at least a threshold separation distance between each of the image representations. The one or more processors are configured to input the canvas image into the image encoder to obtain image tokens associated with cells of the canvas image. The one or more processors are also configured to provide a first input to the LLM, the first input based on the image tokens, to generate a response output.

According to another implementation of the present disclosure, a device includes a memory configured to store a preference order of a plurality of region of interest (ROI) detection modalities and model data associated with a multimodal model that includes an image encoder and a large language model. The device also includes one or more processors coupled to the memory. The one or more processors are configured to obtain image data representing an image. The one or more processors are configured to obtain a first indicator of a first ROI within the image, the first indicator corresponding to a first ROI detection modality of the plurality of ROI detection modalities. The one or more processors are configured to obtain a second indicator of a second ROI within the image, the second indicator corresponding to a second ROI detection modality of the plurality of ROI detection modalities, the second ROI detection modality different from the first ROI detection modality. The one or more processors are also configured to select one of the first ROI or the second ROI, based on the preference order, to process at the multimodal model.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of an example of a system operable to enable multi-ROI processing by a model at inference-time, in accordance with one or more aspects of the present disclosure.

FIG. 2 is a block diagram of an example of components that enable multi-ROI processing by a model at inference-time, in accordance with one or more aspects of the present disclosure.

FIG. 3A, FIG. 3B, FIG. 3C, FIG. 3D, and FIG. 3E are diagrams of examples of operations that enable multi-ROI processing by a model at inference-time, in accordance with one or more aspects of the present disclosure.

FIG. 4 is a diagram of a first example of arranging multiple ROIs into a canvas image for processing by a model at inference-time, in accordance with one or more aspects of the present disclosure.

FIG. 5 is a diagram of a second example of arranging multiple ROIs into a canvas image for processing by a model at inference-time, in accordance with one or more aspects of the present disclosure.

FIG. 6 is a diagram of a third example of arranging multiple ROIs into a canvas image for processing by a model at inference-time, in accordance with one or more aspects of the present disclosure.

FIG. 7 is a block diagram of an example of a multimodal model that supports inference-time multi-ROI processing, in accordance with one or more aspects of the present disclosure.

FIG. 8 is a diagram of an example of an integrated circuit operable to enable multi-ROI processing by a model at inference-time, in accordance with some examples of the present disclosure.

FIG. 9 is a diagram of a mobile device operable to enable multi-ROI processing by a model at inference-time, in accordance with some examples of the present disclosure.

FIG. 10 is a diagram of a headset, such as a virtual reality, mixed reality, or augmented reality headset, operable to enable multi-ROI processing by a model at inference-time, in accordance with some examples of the present disclosure.

FIG. 11 is a diagram of a wearable electronic device operable to enable multi-ROI processing by a model at inference-time, in accordance with some examples of the present disclosure.

FIG. 12 is a diagram of a voice-controlled speaker system operable to enable multi-ROI processing by a model at inference-time, in accordance with some examples of the present disclosure.

FIG. 13 is a diagram of a camera operable to enable multi-ROI processing by a model at inference-time, in accordance with some examples of the present disclosure.

FIG. 14 is a diagram of a vehicle operable to enable multi-ROI processing by a model at inference-time, in accordance with some examples of the present disclosure.

FIG. 15 is a diagram of an example of a method of enabling multi-ROI processing by a model at inference-time, in accordance with some aspects of the present disclosure.

FIG. 16 is a block diagram of an illustrative example of a device that is operable to enable multi-ROI processing by a model at inference-time, in accordance with one or more aspects of the present disclosure.

### V. DETAILED DESCRIPTION

The present disclosure provides systems, apparatus, methods, and computer-readable media for enabling multiple region of interest (multi-ROI) processing by a model at inference-time. Conventional models, such as large multimodal models (LMMs) can use techniques such as visual grounding or referring and text detection to enhance the LMM's understanding of the visual world. However, if a scene contains multiple ROIs, sequentially encoding each of the ROIs as inputs into a LMM can become computationally expensive and introduce additional latency that impacts a user experience.

Aspects disclosed herein enable a model, such as a multimodal model (e.g., an LMM), to perform multimodal ROI detection and multiple ROI packing on a canvas image provided as an input to a model to improve the accuracy of the model and to reduce or eliminate the additional computational expense and latency associated with sequentially encoding multiple ROIs that are detected in a scene as additional model inputs.

In some aspects disclosed herein, a device implements a multimodal model, or another type of model, that is not pretrained or fine-tuned to focus on any particular region of an image. The device obtains image data representing an image in addition to data representing multiple ROIs within the image. The multiple ROIs can be determined based on explicit cues, such as based on a user's gaze or scene-text, and Central-Surround receptive field-based ROI, as non-limiting examples. A logical order for selecting these cues depending on their availability is presented, such as in a smart-glasses implementation, to identify the multiple ROIs within the image.

In some aspects disclosed herein, techniques for packing multiple ROI regions on a canvas image are described. The resulting multi-ROI canvas image can be input to a vision encoder of an LMM to enable simultaneous encoding of multiple ROIs, reducing the computational expense and additional latency associated with sequential encoding of each ROI region at the vision encoder. An example of such techniques can include placing the ROIs on the canvas image with a minimum boundary of separation between adjacent ROIs in both a horizontal (X) and vertical (Y) direction on the canvas image. Another example includes dividing the canvas into a n×n grid of cells, and placing one ROI in each cell, where n is chosen such that n² is greater than or equal to the number of ROIs. Another example includes a heuristic-based method for substantially maximizing separation between the ROIs during placement on the canvas image. Each of these techniques enables sufficient separation to be maintained between the ROIs arranged on the canvas image to prevent interference between adjacent ROIs during encoding of the canvas image.

In some aspects, a method of token pruning is implemented on the multi-ROI canvas image such that tokens falling on ROI-less regions of the canvas image (i.e., regions of the canvas image that do not contain an ROI or a portion of an ROI) can be dropped before being input to the LMM. Pruning tokens that do not correspond to ROIs results in significant computation savings because the complexity of a multi-headed attention (MHA) mechanism in the LLM encoder increases quadratically with the number of tokens.

Particular implementations of the subject matter described in this disclosure can be implemented to realize one or more of the following potential advantages. In some aspects, a technical benefit provided by the disclosed techniques is improved accuracy and utility of responses generated by a model by enabling inference-time multi-ROI-processing by the model. Arranging the ROIs on a canvas image provides the corresponding scene regions to the LMM at higher resolution as compared to the corresponding regions that are provided in a global context image. Conventionally, a lower-resolution global context image is used, and extracting text from the lower-resolution global context image is more difficult or more likely to result in errors. Providing the ROIs arranged on the canvas image enables higher accuracy of processing the ROIs as compared to processing the lower-resolution version of the ROIs from the global context image. Another advantage is that the multiple ROIs on the canvas image can be encoded in a single pass through an image encoder, as compared to conventional techniques in which each of the ROIs is separately encoded, requiring one pass through the image encoder for each encoded ROI. As a result, the disclosed techniques are more computationally efficient and exhibit reduced latency as compared to such conventional techniques. In addition, the number of visual tokens generated by encoding all ROIs as a group using the disclosed techniques is much smaller as compared to the number of tokens generated by encoding each ROI separately, due to the encoding of a single image that includes all of the ROIs producing fewer tokens as compared to the encoding of multiple images which each includes a single ROI. The smaller number of tokens results in enhanced computing and latency efficiency because fewer images are encoded and because the complexity of a multi-headed attention (MHA) mechanism in the LLM encoder increases quadratically with the number of tokens.

An additional advantage is that a single pass encoding of a multi-ROI canvas image results in multiple encoded ROIs that may be used for answering multiple questions regarding the scene, thus reducing or eliminating the need to re-encode ROIs in response to a variety of user questions that relate to different ROIs in the scene. Instead, the multi-ROI canvas image can be encoded a single time, and only the additional user questions need to be retokenized. As a further advantage, the present techniques eliminate any need for selection of a single ROI through explicit referring, which may not be possible for various use cases, such as smart glasses.

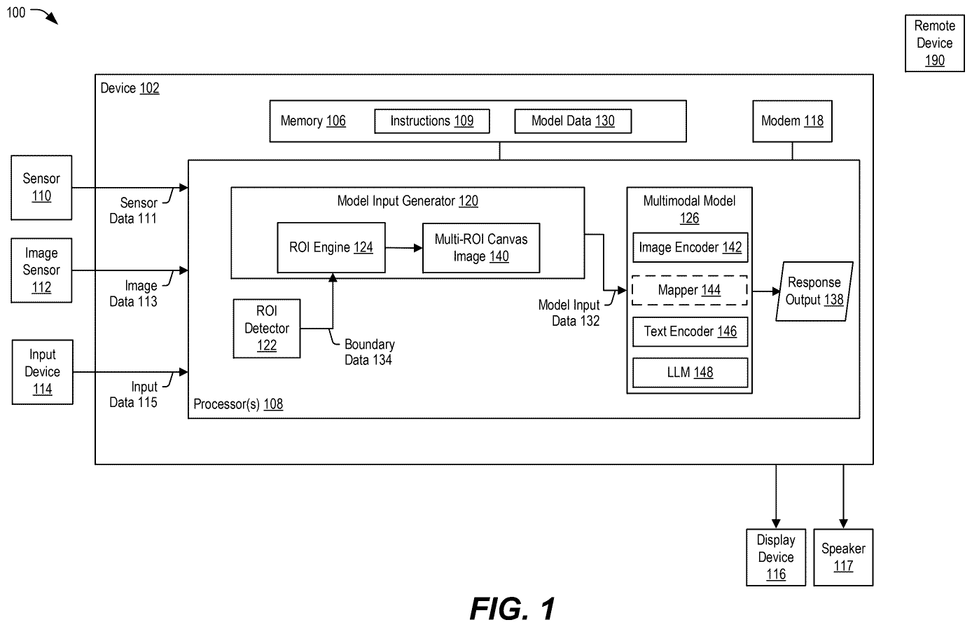

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 108 of FIG. 1), which indicates that in some implementations the device 102 includes a single processor 108 and in other implementations the device 102 includes multiple processors 108. For ease of reference herein, such features are generally introduced as “one or more” features and are subsequently referred to in the singular or optional plural (as indicated by “(s)”) unless aspects related to multiple of the features are being described.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

FIG. 1 is a block diagram of an example of a system 100 operable to enable multi-ROI processing by a model at inference-time, in accordance with one or more aspects of the present disclosure. The system 100 includes a device 102 that is operable to enable multi-ROI processing by a multimodal model 126 (e.g., a large multimodal model (LMM)) at inference-time. The system 100 optionally includes a remote device 190 such that, in some examples, the system 100 includes the remote device 190 and in other examples, the remote device 190 is not included in the system 100. Although described as a remote device, in some other embodiments, the remote device 190 may instead be geographically co-located with the device 102.

The device 102 includes a memory 106, one or more processors 108 (collectively referred to herein as the “processor 108”), and a modem 118. The memory 106 may include one or more memories, such as a single memory or multiple different memories (of the same type or of different types). The memory 106 is configured to store instructions 109 and model data 130. The model data 130 includes or indicates one or more parameters, one or more hyperparameters, configuration data, other data, or a combination thereof, associated with a model that is implemented by the device 102, such as the multimodal model 126. In some examples, the instructions 109, when executed by the processor 108, cause the processor 108 to perform one or more operations described herein. In some examples, the memory 106 stores other information or data, such as thresholds, criterion(s), image data, video data, augmented reality data, applications, or a combination thereof.

The processor 108 includes a model input generator 120, a ROI detector 122, and the multimodal model 126. Each of the model input generator 120, the ROI detector 122, an ROI engine 124 included in the model input generator 120, the multimodal model 126, or a portion thereof, may be implemented by the processor 108 executing instructions (e.g., software), dedicated hardware (e.g., circuitry), a combination thereof. In some aspects, the processor 108 is coupled to one or more image sources (not shown). In some embodiments, the image source(s) provide image data to the processor 108, and can be external to or internal to the device 102. For example, the image source(s) can include input files (e.g., media data) stored in the memory 106 of the device 102, from a game engine, or from an extended reality (XR) engine (e.g., a virtual reality (VR) engine, an augmented reality (AR) engine, or a mixed reality (MR) engine). As another example, the image source(s) can include an image sensor 112 and the processor 108 can receive image data 113 from the image sensor 112. As another example, the image source(s) can include the remote device 190, and image data received from the remote device 190 can be provided to the processor 108 by the modem 118.

The model input generator 120 is configured to generate model input data 132 that is provided as input to the multimodal model 126. For example, the model input generator 120 may be configured to process image data and data that represents a query (e.g., a user question or a question generated by an application or received from another device) to be answered by the multimodal model 126 to generate image features and text features, respectively, and the model input data 132 may be based on the image features and the text features. For example, the model input data 132 may be based on the image data 113 (or an image from another image source) and a query (e.g., a question) represented by input data 115 from an input device 114 (or a question from another source, such as an application executed by the processor 108 or received from the remote device 190).

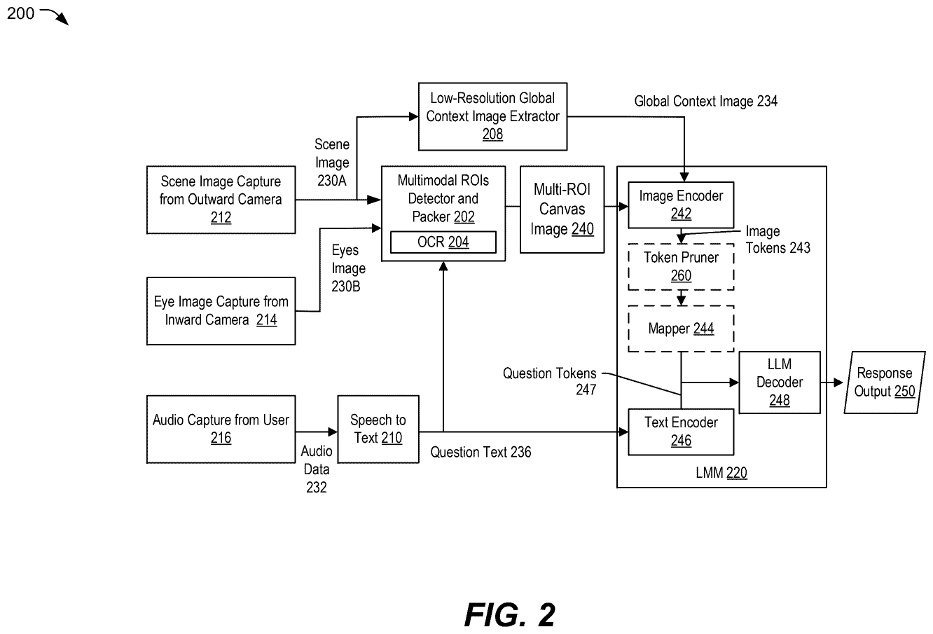

In some implementations, the model input generator 120 is configured to divide the image into a set of tiles that each have a corresponding size that is based on a size criterion associated with the multimodal model 126. For example, the multimodal model 126 may be configured to receive images that have a particular size or aspect ratio, and the model input generator 120 may scale and divide (e.g., tile) the image represented by the image data 113 into multiple tiles (e.g., image portions or sub-images) that each have the same particular size or aspect ratio associated with the multimodal model 126 (e.g., an image encoding and mapping model). In such implementations, the model input data 132 includes the set of tiles. In other implementations, the tiling is omitted, and the model input data 132 represents the image as a whole and the query. Additionally, or alternatively, the model input generator 120 may be configured to scale the image as a context image according to the size or aspect ratio criterion. In some other embodiments, the query is omitted (e.g., for a multimodal model that is trained for a different purpose than answering text-based questions). Additional examples of operations performed by the model input generator 120 are further described herein with reference to FIG. 2.

The ROI detector 122 is configured to determine boundaries of one or more ROIs within an image indicated by image data received from the image source, such as image data 113 from an image sensor 112. For example, the ROI detector 122 may determine a bounding box (or other boundary shape) of a ROI within an image, and the ROI detector 122 may output coordinates of one or more pixels of the boundary, dimensions (e.g., height, width), or other boundary characteristics as boundary data 134. As an illustrative example, the boundary data 134 may represent or indicate an upper left corner of the boundaries of an ROI within an image, a height of the boundaries, and a width of the boundaries. In some aspects, the ROI detector 122 is configured to determine the boundaries (e.g., the boundary data 134) based on sensor data 111 from a sensor 110. To illustrate, the sensor 110 may be configured to detect a characteristic that indicates boundaries of one or more ROIs, and the sensor data 111 may represent the detected characteristic, which is provided to the ROI detector 122 for determining the boundary data 134. The characteristic may include a gaze of a user or an orientation of the user's head or the device 102 that represents the boundaries, or other types of conditions, such as detection of text in the image data 113, as further described herein. As another example, the sensor 110 may include one or more microphones that are configured to generate audio data (e.g., the sensor data 111) that represents user speech that includes a description of the boundaries. Thus, data representing one or more ROIs can include referring based on the audio data.

In some embodiments, the ROI detector 122 is configured to determine the ROI based on additional information that may be received in conjunction with the image data 113, such as when the image data 113 represents a pair of stereo images, when the image data 113 represents a sequence of images to enable optical flow techniques, or when additional sensor data is provided from a sensor system such as lidar or structured light.

In some embodiments, the boundary data 134 may be determined based on input data 115 from an input device 114. For example, the input device 114 may include a touchscreen, and a user may mark the boundaries of the ROI in the image on the touchscreen. In this example, the input data 115 may represent or indicate the boundaries of the ROI, and the boundary data 134 may be generated based on the input data 115. As another example, the input device 114 may include a keypad or a touchscreen, and the input device 114 may be configured to generate text data (e.g., the input data 115) based on user input that represents or indicates the boundaries of the ROI. In some other embodiments, the ROI detector 122 may be configured to supplement boundaries indicated by the input data 115 with additional boundary determinations based on the sensor data 111.

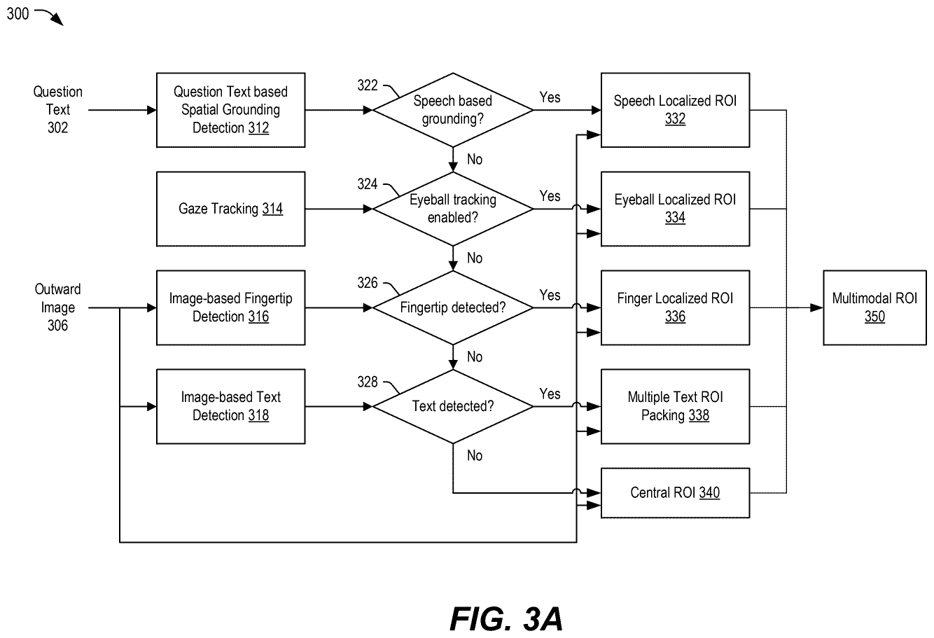

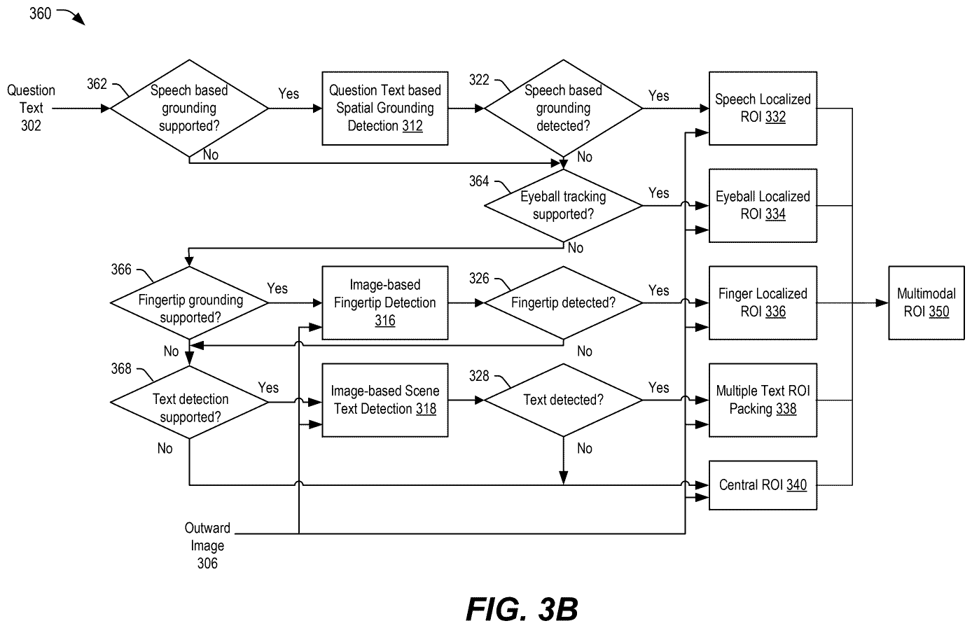

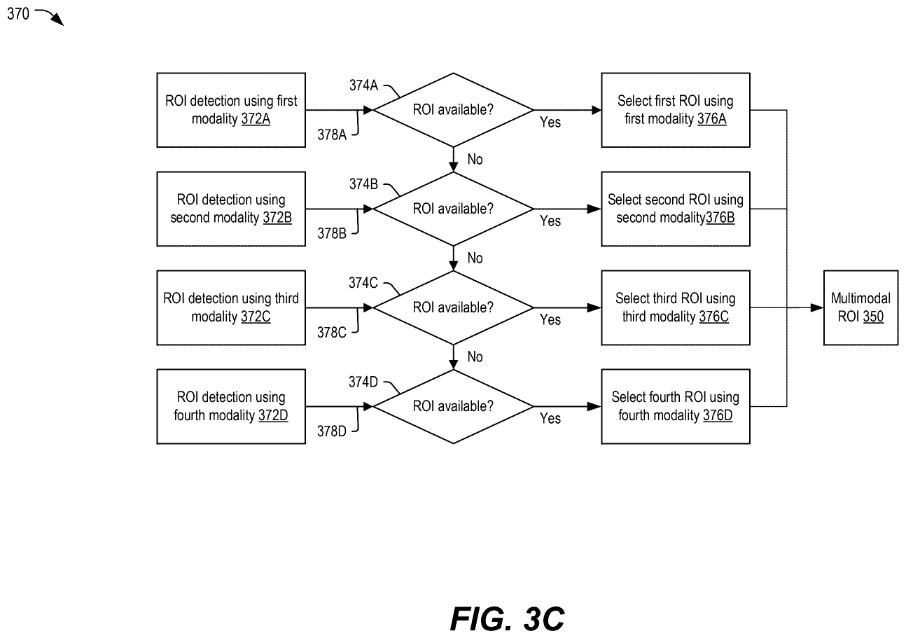

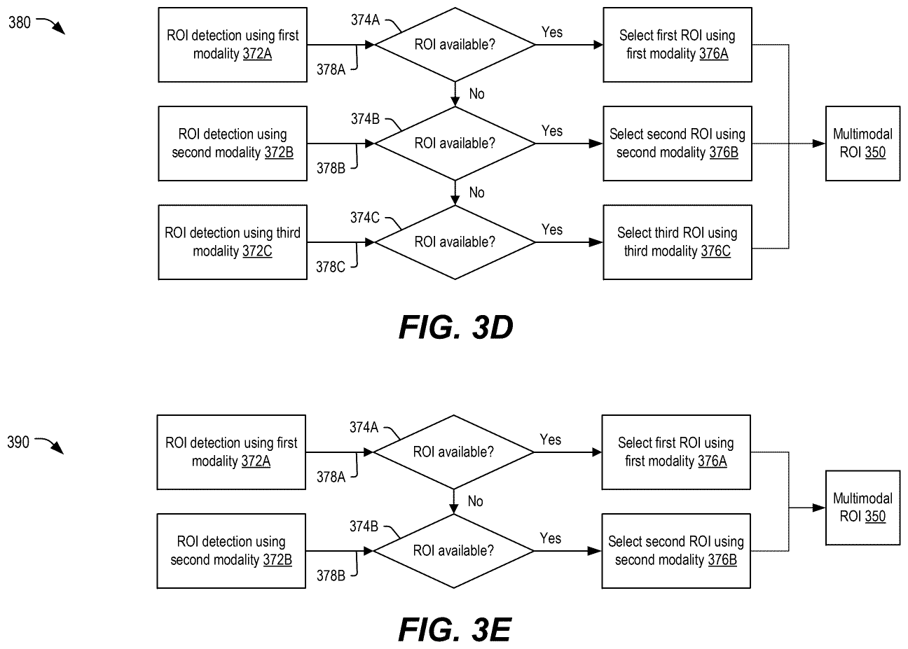

The ROI engine 124 is configured to obtain data representing multiple ROIs within the image data 113. For example, the data representing the multiple ROIs may be received via the boundary data 134, generated at the ROI engine 124, or a combination thereof. According to an aspect, the multiple ROIs include one or more ROIs that include text, also referred to herein as “text-based ROIs.” In an example, the image data 113 represents an image of a scene that includes multiple regions of visible text, such as signs, license plates, books, documents, menus, etc., which may be identified at the ROI detector 122, the ROI engine, or a combination thereof, via text detection processing the image data 113. Examples of multimodal ROI detection are described in further detail with reference to FIG. 2 and FIGS. 3A-3E.

The ROI engine 124 is configured to arrange image representations of the ROIs into a single canvas image to generate a multi-ROI canvas image 140. In an example, for each detected ROI in the scene, the ROI engine 124 generates an image representation of that ROI by copying a portion of the image data 113 corresponding to that ROI. To illustrate, the ROI engine 124 can copy the pixel data for pixels that are within the region of the image that is designated by the boundary data 134 for each ROI. The ROI engine 124 inserts the image representations of the ROIs into a blank canvas image to generate the multi-ROI canvas image 140. As used herein, a “canvas image” indicates an image that is generated by insertion of one or more graphical objects (e.g., pixel data from the ROIs in the image data 113), as compared to images that are captured by sensors (e.g., the image data 113 from the image sensor 112).

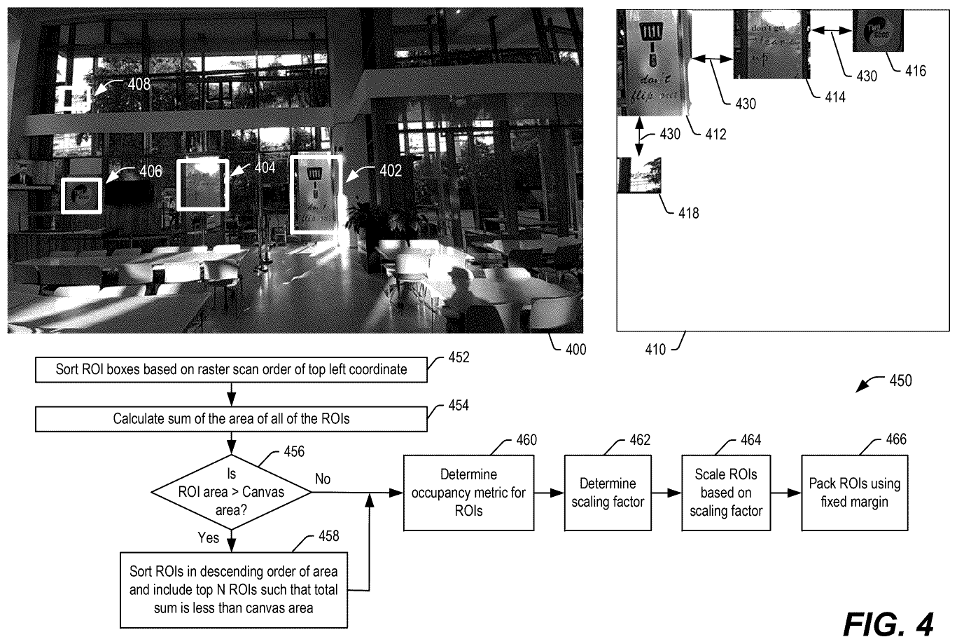

The ROI engine 124 may utilize one or more packing techniques to arrange the image representations of the ROIs into the multi-ROI canvas image 140 to ensure that at least a threshold distance separates each of the ROIs from the other ROIs. The threshold distance can ensure a minimum separation amount that enables separate encoding of each of the image representations in the multi-ROI canvas image 140 without interference between neighboring image representations. Such packing techniques may include performance of sorting, scaling, or other operations on the image representations of the ROIs, such as described further with reference to FIGS. 4-6. The multi-ROI canvas image 140 is provided to the multimodal model 126 as part of the model input data 132.

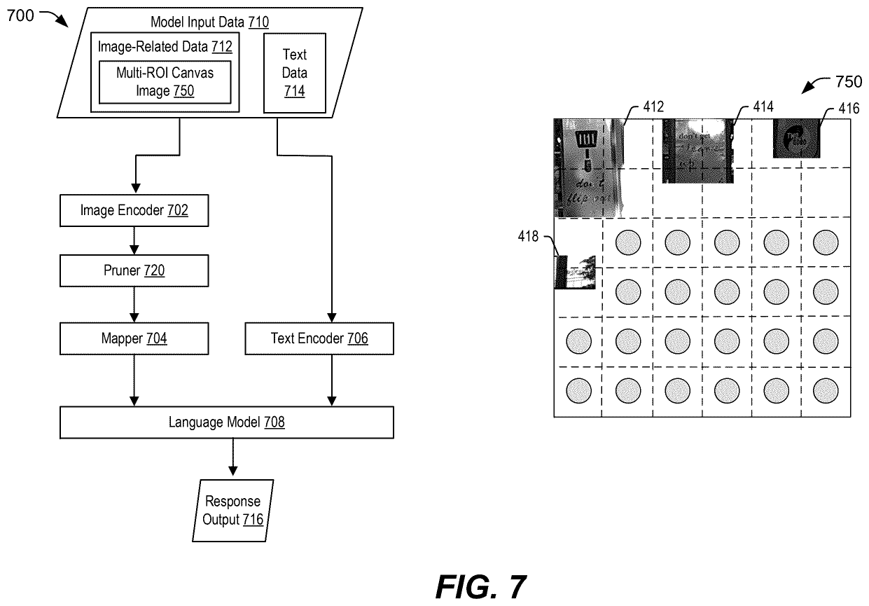

The multimodal model 126 is configured to process data from multiple modalities to generate a response output 138 that represents an answer to a question (e.g., query), such as a question indicated by the input data 115. For example, the multimodal model 126 may be configured to process image data (e.g., still images, video frames, etc.) and text data and to generate the response output 138 based on knowledge from a corpus of documents (or another knowledge base) and input image data to provide the response output 138 that represents the most likely answer to the question. The multimodal model 126 may be pretrained to process image data and text data, and not be pretrained or fine-tuned to process ROI-related input data, such as an off-the-shelf multimodal model (e.g., an LMM). In some aspects, the multimodal model 126 includes an image encoding and mapping model, illustrated as an image encoder 142 and an optional mapper 144, a text encoding model, illustrated as a text encoder 146, and a language model, illustrated as a large language model (LLM) 148, as further described with reference to FIG. 7.

According to an aspect, the multimodal model 126 is configured to process the model input data 132 to generate the response output 138. To generate the response output 138, the multimodal model 126 inputs image data to the image encoder 142 and text data to the text encoder 146. The image encoder 142 may process each image represented by the model input data 132 as an array of portions or “cells” and generate a token (e.g., a compressed representative unit in a latent space smaller than the original image space, such as an embedding vector or textual description) for each cell, resulting in a set of tokens for each of the images. The tokens output by the image encoder 142 are also referred to herein as “image tokens.” As an example, the multimodal model 126 inputs the multi-ROI canvas image 140 into the image encoder 142 to obtain image tokens associated with cells of the multi-ROI canvas image 140.

Optionally, the multimodal model 126 is configured to prune image tokens from the set of image tokens generated from the multi-ROI canvas image 140, by removing one or more of the image tokens, before sending the remaining pruned set (e.g., a subset) of the image tokens as inputs to the mapper 144 or to the LLM 148. As explained further with reference to FIG. 2 and FIG. 7, the omitted image tokens can correspond to cells of the multi-ROI canvas image 140 that do not contain pixels of any of the ROIs and that therefore do not contain useful information.

In some embodiments, the image encoder 142 is configured to generate image tokens that are in a same token space (e.g., a “text space”) as the output of the text encoder 146; in such embodiments, the optional mapper 144 is omitted and the image tokens (or, if pruning is performed, a pruned set of the image tokens) that are output from the image encoder 142 are provided as a first input to the LLM 148. In other embodiments in which the image tokens generated by the image encoder 142 are not in the same token space as the output of the text encoder 146, the image tokens (or, if pruning is performed, a pruned set of the image tokens) are provided as an input to the mapper 144 (e.g., a text mapper). The mapper 144 is configured to map the input image tokens into output image tokens (e.g., “image tokens in text space”) that are in the same token space as the output of the text encoder 146. In such embodiments, an output of the mapper 144 is provided as the first input to the language model (e.g., the LLM 148).

The image tokens that are provided as the first input to the LLM 148, along with a second input (e.g., “question tokens”) generated by the text encoder 146 processing of the query, is used by the language model to generate the response output 138.

The language model is configured to generate the response output 138 based on the output of the image encoding and mapping model and of the text encoding model. For example, the language model may include an off-the-shelf language model, such as the LLM 148, that is trained to answer a question indicated by the output of the text encoding model based on trained knowledge and image-related data indicated by the output of the image encoding and mapping model. Additional details of the multimodal model 126 are described further herein with reference to FIG. 7. The multimodal model 126 may be trained at the device 102 or may be received after training at another device, such as the remote device 190 (e.g., a remote server that transmits the model data 130 to the device 102). Although embodiments described herein include the multimodal model 126, in other embodiments, the processor 108 may include or have access to a text model but not image encoding and mapping models, and the image data 113 may be encoded and mapped to the token space by one or more additional models (e.g., one or more image models at another device, such as the remote device 190) or may be encoded and mapped using other techniques.

The modem 118 is coupled to the processor 108 and is configured to transmit text data or multimedia data (e.g., the response output 138) to a second device, such as via a wireless transmission to the remote device 190 (e.g., a remote server). Additionally, or alternatively, the modem 118 is configured to transmit other data, such as image data, video data, audio data, or a combination thereof, to the remote device 190. In some embodiments, the modem 118 may be configured to receive data from another device, such as the remote device 190 (e.g., a remote server or user device). For example, the data received by the modem 118 may include the image data 113, data representing the query, data representing one or more of the multiple ROIs (e.g., the sensor data 111, the input data 115, or both), the model data 130, media data (e.g., image data, video data, or audio data), other input(s), or a combination thereof.

The processor 108 is also coupled to a sensor 110, an image sensor 112, an input device 114 (e.g., a microphone, a keyboard or touch screen, etc.), a display device 116, and a speaker 117. The sensor 110 may include one or more orientation sensors, one or more position sensors, one or more inertial sensors (e.g., an inertial measurement unit (IMU)), a gaze detection sensor (e.g., a user-facing camera), one or more microphones or other audio capture devices, or a combination thereof. The sensor 110 is configured to generate sensor data 111 that indicates one or more sensed conditions associated with the device 102, such as an orientation, a position, a velocity, an acceleration, a gaze direction of a user of the device 102, a command associated with the device 102, or a combination thereof. The image sensor 112 may include one or more cameras and may be configured to generate image data 113. The input device 114 is configured to receive an input and provide the input to the processor 108 as input data 115. For example, the input device 114 may include a keyboard, a keypad, a touch screen, or one or more microphones configured to receive the input and provide the input data 115 (e.g., an input signal) to the processor 108. In some examples, the input data 115 includes text data that indicates or represents boundaries of an ROI, a query, or a combination thereof. In some examples, the input data 115 includes audio data that represents user speech that indicates or represents boundaries of an ROI, a query, or a combination thereof.

The display device 116 is coupled to the processor 108 and is configured to output one or more displayable outputs to a user of the device 102. The displayable output(s) may include the image data 113 representing the image, an indication of the ROI of the image, media data based on the image data 113, the response output 138, other visual output(s), or a combination thereof. In some examples, the display device 116 includes a display screen, a monitor or television, a projector, or a combination thereof. The speaker 117 is coupled to the processor 108 and is configured to output one or more audio outputs. For example, the speaker 117 may output audio that corresponds to media data stored at the memory 106 or received from another device, audio that corresponds to media data that includes the image data 113, audio that corresponds to the response output 138, other audio, or a combination thereof.

The sensor 110, the image sensor 112, the input device 114, the display device 116, the speaker 117, or a combination there may be coupled to or integrated within the device 102. Although the device 102 is described as being coupled to or including the sensor 110, the image sensor 112, the input device 114, the display device 116, the speaker 117, and the modem 118, in other implementations the device 102 may not include or be coupled to the sensor 110, the image sensor 112, the input device 114, the display device 116, the speaker 117, the modem 118, or a combination thereof. As such, any of the sensor 110, the image sensor 112, the input device 114, the display device 116, the speaker 117, or the modem 118 may be optional and, in embodiments in which such component(s) are not included in or coupled to the device 102, the corresponding data may be received from, or transmitted to, another device, such as the remote device 190.

During operation of the system 100, the processor 108 obtains input image data and query data that is provided to the model input generator 120 to generate the model input data 132. The input image data may include or correspond to the image data 113 generated by the image sensor 112, image data stored at the memory 106, image data generated by an application executed by the processor 108, image data received from the remote device 190, or a combination thereof. The query data may include or correspond to the input data 115 generated by the input device 114 and may represent a query (e.g., a question) to be answered by the multimodal model 126. As an illustrative example, the image data 113 may represent an image of a table with a plate of food and a bottled beverage, and the input data 115 may represent the question “What is the price of the beverage on the table?” In this example, including ROI-related data as input to the multimodal model 126 may enable the multimodal model 126 to correctly identify that the beverage is a particular brand of soda (e.g., based on image-related data, optical character recognition (OCR) data, etc.). To illustrate, one or more portions of the image data 113 that includes text that describes the name of beverage and a price of the beverage (e.g., one or more of a product label, placard, menu, sign, etc.) may be identified by the ROI detector 122 and/or the ROI engine 124, included in the multi-ROI canvas image 140, and used to provide the response output 138. Alternatively, or additionally, the multimodal model 126 may correctly identify the name and/or price of the beverage based on other knowledge on which the multimodal model 126 was trained, and may output a price of the particular brand of soda at a store that is geographically near the user as the response output 138. Although described as being a user-generated question that is indicated by the input data 115, in other embodiments, the query may be generated by the processor 108, such as by an application executed by the processor 108, or received from the remote device 190.

The model input generator 120 generates the model input data 132 based on the image data 113 and the input data 115 (e.g., based on the image and the query). For example, the model input generator 120 may generate image-related input data based on the image data 113 and text-related input data based on the input data 115. In some embodiments, to generate the image-related input data, the model input generator 120 may process and divide (e.g., logically allocate portions of) the image represented by the image data 113 into a set of tiles that each have a corresponding size that is based on a size criterion associated with the multimodal model 126 (e.g., the image encoder 142 and the mapper 144 included in the multimodal model 126). As an example, the image may have a height that is approximately twice a height criterion associated with input to the multimodal model 126 and a width that is approximately twice a width criterion associated with input to the multimodal model 126. In this example, the model input generator 120 divides the image into four non-overlapping equal-sized tiles that each have a height and width that satisfy the height and width criteria. It should be understood that the image including non-overlapping equal-sized tiles is provided as an illustrative example, in other examples the image can include two or more overlapping tiles, can include at least one tile that has a different size than another tile, or both. The tiles, or features derived from the tiles, are included in the model input data 132. Additionally, in some aspects, the model input generator 120 may also generate a context image input based on an entirety of the image. For example, the model input generator 120 may scale the image to satisfy the height and width criteria associated with the multimodal model 126 to generate a context image input that is included in the model input data 132, or that is used to derive features that are included in the model input data 132. In some embodiments, the context image input is a lower definition image than the tiles. To generate the text-related input data, the model input generator 120 may process the input data 115 to generate text data that represents the query, and the text data, or features derived from the text data, is included in the model input data 132.

In addition to obtaining the input image data and the query data, the processor 108 obtains data that indicates one or more ROIs within the image. For example, the processor 108 is configured to identify one or more text-based ROIs based on detection of text in the image, such as by performing text detection processing of the image data 113 at the ROI detector 122 and/or at the ROI engine 124 to detect regions within the image that include text. Alternatively, or in addition, one or more ROIs may be selected by the user, such as by tracing boundaries of a ROI in the image using a touchscreen (e.g., the input device 114), or determined based on one or more sensed conditions associated with the device 102 or the user. For example, the user may provide user input via the input device 114 that indicates one or more ROIs, and the processor 108 may determine the boundary data 134 that indicates boundaries of the ROIs based on the input data 115. In such an example, the input data 115 may indicate both the query and the ROIs. In another example, the boundary data 134 may be determined based on the sensor data 111 from the sensor 110 that indicates a sensed condition that is indicative of the ROIs, the image data 113, the input data 115, or a combination thereof. In some aspects, processor 108 includes the ROI detector 122, and the ROI detector 122 detects a boundary associated with one or more of the ROIs and generates the boundary data 134. Additional details of multimodal detection of ROIs are described further herein with reference to FIG. 2 and FIGS. 3A-3E.

In addition to the tiles, the context image, or both, the model input data 132 also includes the multi-ROI canvas image 140 that is generated by the ROI engine 124 by arranging image representations of the ROIs into the multi-ROI canvas image 140, such as described in further detail with reference to FIGS. 4-6. In some examples, the multi-ROI canvas image 140 can have a size and shape that satisfies the height and width criteria of the multimodal model 126 (e.g., the image encoder 142).

The multimodal model 126 receives the model input data 132 including the multi-ROI canvas image 140 and generates the response output 138 based on the model input data 132. As further described with reference to FIG. 7, the multimodal model 126 may include image models (e.g., the image encoder 142), mapping models (e.g., the optional mapper 144), and a text model (e.g., the LLM 148), and the multimodal model 126 may convert input image features of the model input data 132 to a common token space (e.g., the “text space”) into which text features of the model input data 132 are also mapped. After the features are mapped to the common token space, the tokens may be flattened and concatenated to be provided as inputs to the text model to generate the response output 138. The response output 138 represents a response to the question (e.g., query) indicated by the input data 115 using information on which the multimodal model 126 is trained and with a focus on the ROIs in the multi-ROI canvas image 140.

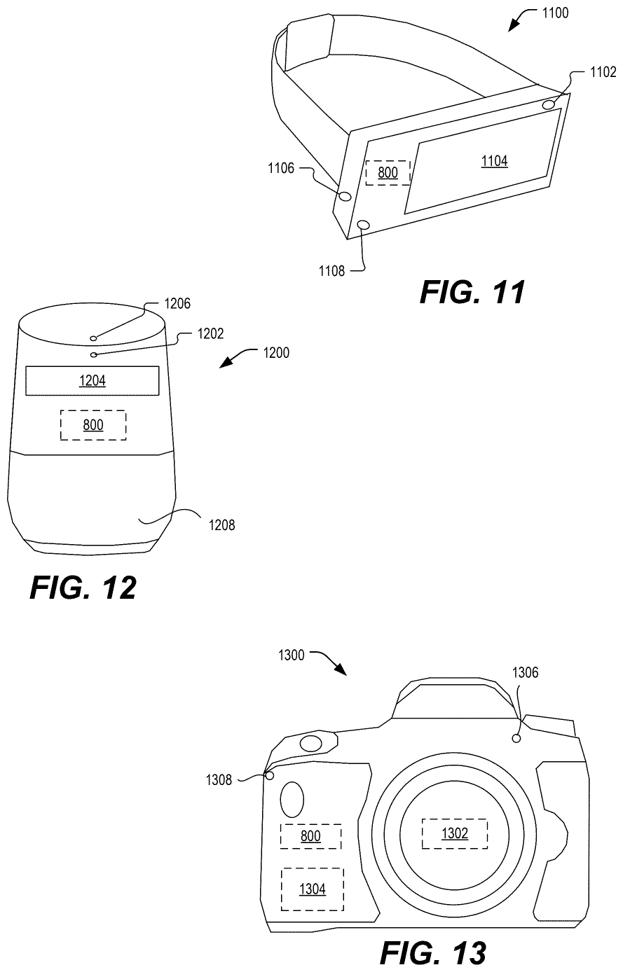

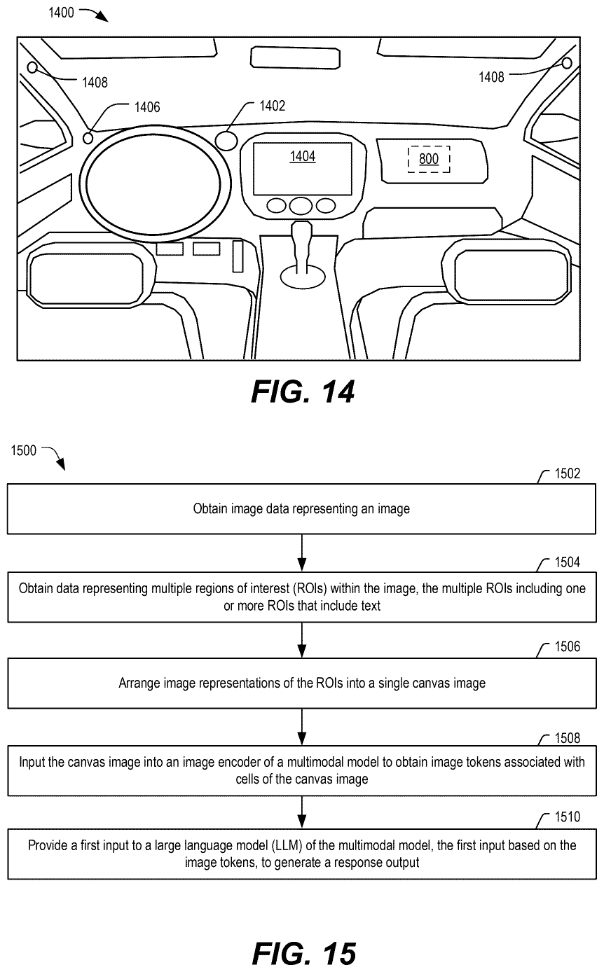

In some examples, the device 102 corresponds to or is included in one of various types of devices, such that the processor 108 can be integrated in multiple types of devices. In an illustrative example, the processor 108 is integrated in a wearable electronic device as depicted in FIG. 11, a virtual reality, mixed reality, or augmented reality headset as depicted in FIG. 10, or another wearable device. In another illustrative example, the processor 108 is integrated in a mobile device (a mobile phone or a tablet) as depicted in FIG. 9, a voice-controlled speaker system as depicted in FIG. 12, a camera as depicted in FIG. 13, a vehicle as depicted in FIG. 14, a computer (e.g., a laptop computer) or a server, or another system or device.

According to an aspect, the device 102 is configured, based on the response output 138, to: i) control a machine such as a vehicle, a robot, an appliance, a mobile device, a camera; ii) control an actuator such as an electromechanical actuator, an electrohydraulic actuator, an electroactive polymer actuator; iii) control an active circuit component such as a voltage or current source, a transistor, an amplifier, an integrated circuit, a programmable device such as field programmable gate array (FPGA), a display device; iii) provide a notification to a user, such as a visual, auditory or haptic notification or combination thereof, iv) launch, close, pause or suspend an application on a computer; iv) launch, close, pause or suspend playback of audio-visual (AV) media on a computer; or v) provide a control signal to initiate any of the above.

In a particular example, the device 102 includes a memory (e.g., the memory 106) configured to store model data (e.g., the model data 130) associated with a multimodal model (e.g., the multimodal model 126) that includes an image encoder (e.g., the image encoder 142) and a large language model (e.g., the LLM 148). The device 102 also includes one or more processors (e.g., the processor 108) coupled to the memory. The one or more processors are configured to obtain image data (e.g., the image data 113) representing an image. The one or more processors are also configured to obtain data (e.g., the sensor data 111, the image data 113, the input data 115, the boundary data 134, or a combination thereof) representing multiple ROIs within the image, the multiple ROIs including one or more text-based ROIs. The one or more processors are also configured to arrange image representations of the ROIs into a single canvas image (e.g., the multi-ROI canvas image 140). The one or more processors are also configured to input the canvas image into the image encoder to obtain image tokens associated with cells of the canvas image. The one or more processors are also configured to provide a first input to the LLM, the first input based on the image tokens, to generate a response output (e.g., the response output 138).

One technical advantage of implementing the device 102 as described above is improved accuracy and utility of responses generated by the multimodal model 126 by enabling inference-time multi-ROI processing by the multimodal model 126. Arranging the ROIs on the multi-ROI canvas image 140 provides the corresponding scene image regions to the multimodal model 126 at higher resolution as compared to the corresponding regions that are provided in a global context image, enabling higher accuracy of processing the ROIs as compared to processing the lower-resolution version of the ROIs from the global context image. Another advantage is that the multiple ROIs on the multi-ROI canvas image 140 can be encoded in a single pass through the image encoder 142, as compared to conventional techniques in which the ROIs are separately encoded, requiring one pass through an image encoder for each encoded ROI.

An additional advantage is that a single pass encoding of the multi-ROI canvas image 140 results in multiple encoded ROIs that may be used for answering multiple questions regarding the scene, thus reducing or eliminating the need to re-encode ROIs in response to a variety of user questions that relate to different ROIs in the scene. Instead, the multi-ROI canvas image 140 can be encoded a single time, and only the user questions are retokenized. As a further advantage, the present techniques eliminate any need for a single ROI selection through explicit referring, which may not be possible for various use cases, such as smart glasses.

FIG. 2 is a block diagram of an example of components 200 of a device operable to enable multi-ROI processing by a model at inference-time, in accordance with one or more aspects of the present disclosure. The components 200 include a multimodal ROI detector and packer 202 that includes an OCR module 204, a low-resolution global context image extractor 208, a speech to text module 210, and an LMM 220. In some embodiments, the components 200 of FIG. 2 include or correspond to components of the device 102 of FIG. 1. For example, the multimodal ROI detector and packer 202 may include or correspond to the ROI engine 124 and the ROI detector 122. The low-resolution global context image extractor 208 and the speech to text module 210 may include or correspond to the model input generator 120. The LMM 220 may include or correspond to the multimodal model 126. The LMM 220 includes an image encoder 242, an optional mapper 244, a text encoder 246, and an LLM decoder 248 that may include or correspond to the image encoder 142, the mapper 144, the text encoder 146, and the LLM 148, respectively, of the multimodal model 126. Optionally, the LMM 220 also includes a token pruner 260.

Each of components 200, or portion(s) thereof, may be implemented by a processor (e.g., the processor 108) executing instructions (e.g., software), dedicated hardware (e.g., circuitry), or a combination thereof. Additionally, or alternatively, although illustrated in FIG. 2 as separate components, in other embodiments, one or more of the multimodal ROI detector and packer 202, the OCR module 204, the low-resolution global context image extractor 208, the speech to text module 210, or the LMM 220 may be included in or integrated within a single component that is configured to perform the operations described with reference to the respective components.

The multimodal ROIs detector and packer 202 is configured to obtain image data 230. The image data 230 includes scene image data 230A that is obtained from a scene image capture operation 212 from an outward-facing camera, such as the image data 113 from the image sensor 112. The image data 230 also includes eyes image data 230B that is obtained from an eye capture operation 214 from an inward-facing camera. To illustrate, the eyes image data 230B may be obtained from a gaze tracking camera, such as an inward-facing camera of a head-mounted device worn by a user, and the eyes image data 230B may be processed by the multimodal ROIs detector and packer 202 to detect one or more ROIs based on where the user is looking. As a particular example, the multimodal ROI detector and packer 202 may receive the eyes image data 230B from a gaze tracking camera that tracks a direction of the user's gaze, and the multimodal ROI detector and packer 202 may identify a region of an image that is captured by a camera in the same direction as the user's gaze and that corresponds to the center of the user's gaze. The multimodal ROIs detector and packer 202 is also configured to process the scene image data 230A at the OCR module 204 to detect one or more regions of the scene that contain text, and identify such text-containing regions as text-based ROIs.

The multimodal ROI detector and packer 202 is also configured to receive a text input, illustrated as question text data 236, and process the question text data 236 to determine whether one or more ROIs are identified in the text input. For example, audio data 232 is obtained from an audio capture from user operation 216, such as at one or more microphones (e.g., included in or corresponding to the input device 114) or other audio capture device or sensor. The audio data 232 is processed at the speech to text module 210 to generate the question text data 236, and the question text data 236 may be processed at the multimodal ROI detector and packer 202 to identify user speech that includes a description of a ROI. For example, the multimodal ROI detector and packer 202 may include or have access to a natural language processing (NLP) module that processes the question text data 236 to identify referring of one or more ROIs.

Although not illustrated, in some embodiments the multimodal ROI detector and packer 202 is also configured to receive other sensor data that indicates one or more ROIs. For example, the multimodal ROI detector and packer 202 may receive sensor data (e.g., the sensor data 111) from an orientation sensor, an accelerometer, a velocity sensor, an IMU, an audio capture device (e.g., a microphone), or another type of sensor, and the multimodal ROI detector and packer 202 may process the sensor data to determine the boundaries of one or more ROIs represented by the sensor data. As another example, one or more of the components 200 may be included in a head-mounted device such as a headset, a glasses device, or the like, and the multimodal ROI detector and packer 202 may receive orientation data from an orientation sensor of the head-mounted device that indicates an orientation of the user. The multimodal ROI detector and packer 202 may determine a region of an image (e.g., from one or more cameras of the head-mounted device) that corresponds to the user's gaze based on the orientation data. The above-described examples are illustrative, and in other embodiments, the multimodal ROI detector and packer 202 may determine one or more other ROIs based on other sensor data from other sensors or using other techniques.

The multimodal ROIs detector and packer 202 is configured to arrange image representations of each of the identified ROIs into a canvas image to generate a multi-ROI canvas image 240, which may correspond to the multi-ROI canvas image 140. For example, the multimodal ROIs detector and packer 202 may arrange the image representations of the ROIs into the multi-ROI canvas image 240 to ensure that at least a threshold distance separates each of the ROIs from the other ROIs. The threshold distance enables encoding of each of the image representations in the multi-ROI canvas image 240 without interference between neighboring image representations of other ROIs in the multi-ROI canvas image 240. Such packing techniques may include performance of sorting, scaling, or other operations on the image representations of the ROIs, such as described further with reference to FIGS. 4-6.

The low-resolution global context image extractor 208 is configured to generate global context image data 234 that represents the image as a whole (e.g., a context image) in a format that conforms to an input specification of the LMM 220. For example, the low-resolution global context image extractor 208 may upscale or downscale a size of the image represented by the scene image data 230A to the particular size specified for input to the image encoder 242, and the low-resolution global context image extractor 208 may pad the image (e.g., add padding pixels to regions at the top, the left, the right, or the bottom of the image) such that an aspect ratio of the global context image data 234 is the same as a particular aspect ratio specified for input to the image encoder 242 (e.g., the aspect ratio satisfies an aspect ratio criterion). In some embodiments, the low-resolution global context image extractor 208 is configured to receive or output a lower resolution version of the scene image data 230A (or the context image represented by the global context image data 234), as compared to the image representations of the ROIs in the multi-ROI canvas image 240.

The multi-ROI canvas image 240, the global context image data 234, and the question text data 236 are input to the LMM 220. The question text data 236 is processed at the text encoder 246, and the multi-ROI canvas image 240 and the global context image data 234 are each encoded at the image encoder 242. In some embodiments, the question text data 236 includes or corresponds to a user voice input that indicates a question (e.g., a query) that the user is providing to the LMM 220 to receive a response. In other implementations, the question text data 236 may include text data based on a user input received via a touchscreen, a keypad, or the like, instead of or in addition to the audio data 232. In embodiments in which image tiles are generated, such as described with reference to FIG. 1, such tiles are also input to the LMM 220 and encoded at the image encoder 242.

The LMM 220 may receive the respective input data and generate a response output 250 that answers the query indicated by the question text data 236 and that is based on the image data 230 and one or more ROIs within an image. For example, the response output 250 may include or correspond to the response output 138 of FIG. 1. In a particular embodiment, each image (e.g., the multi-ROI canvas image 240 and the global context image data 234) that is input to the image encoder 242 is encoded to generate a corresponding set of image tokens corresponding to an array of cells (e.g., logical subdivisions) of the image. In some embodiments, the image encoder 242 is configured to generate image tokens 243 that are in a same token space as the output of the text encoder 246; in such embodiments, the optional mapper 244 is omitted and the image tokens 243 (or, if pruning is performed, a pruned set of the image tokens 243) that are output from the image encoder 242 are provided as inputs to the LLM decoder 248. In other embodiments in which the image tokens 243 generated by the image encoder 242 are not in the same token space as the output of the text encoder 246, the image tokens 243 (or, if pruning is performed, a pruned set of the image tokens 243) are provided as an input to the mapper 244 (e.g., a text mapper), which generates an output of image tokens in text space that is provided as an input to the LLM decoder 248.

The input of image tokens in text space received by the LLM decoder 248 (e.g., from the image encoder 242 or from the optional mapper 244), together with an input of question tokens 247 generated by processing the question text data 236 by the text encoder 246, is used by the LLM decoder 248 to generate the response output 250.

In embodiments in which the optional token pruner 260 is included in the LMM 220, the token pruner 260 is configured to prune image tokens from the set of image tokens 243 generated for the multi-ROI canvas image 240 before sending the remaining image tokens 243 to the LLM decoder 248 or to the mapper 244. For example, the pruned image tokens can correspond to cells of the multi-ROI canvas image 240 that do not contain pixels of any of the ROIs and that therefore do not contain useful information. Reducing the number of image tokens associated with the multi-ROI canvas image 240 by removing image tokens that do not contain useful information reduces the input size to the LLM decoder 248 and reduces computation load and latency associated with generating the response output 250, such as by reducing an input size to an attention mechanism of the LLM decoder 248, as described further with reference to FIG. 7.

FIG. 3A is a diagram of an example of operations 300 that enable multi-ROI processing by a model at inference-time, in accordance with one or more aspects of the present disclosure. In some examples, one or more of the operations 300 of FIG. 3A may be performed by the processor 108 (e.g., the ROI detector 122, the model input generator 120, the ROI engine 124, or a combination thereof) of FIG. 1, the multimodal ROIs detector and packer 202 of FIG. 2, or both.

The operations 300 include a question text based spatial grounding detection operation 312 that is performed on question text 302. For example, the question text 302 can include text of user speech, and may include or correspond to the question text data 236 of FIG. 2. The question text based spatial grounding detection operation 312 processes the question text 302 to determine whether the text identifies a region of a scene. For example, the user may ask the question, “who are the people in the picture on the wall above the mantle?” which indicates a spatial region of the scene about which the question is directed and thus indicates a ROI (e.g., a region substantially bounded by the borders of the picture). A result of the question text based spatial grounding detection operation 312 is processed to determine whether speech based grounding is detected, at operation 322. In response to speech based grounding being detected, a speech localized ROI operation 332 is performed. For example, the speech localized ROI operation 332 can include determining a boundary of the ROI based on the spatial information provided in the question text 302, and a portion of outward image data 306 (e.g., an image of the scene captured by an outward-facing camera, e.g., of a headset device worn by the user) within the boundary can be identified as the ROL In an example, the outward image data 306 can correspond to the image data 113 of FIG. 1, the scene image data 230A of FIG. 2, or both.

The operations 300 include a gaze tracking operation 314 that can be performed, such as by an inward facing camera on a headset, to track a user's gaze. For example, the gaze tracking operation 314 can include tracking the orientation of a user's eyeball(s) to identify a region of the scene that the user is looking at. The gaze tracking operation 314 may be performed by, or based on data from, the sensor 110 of FIG. 1, the eye image capture operation 214 of FIG. 2, or both. A result of the gaze tracking operation 314 is processed to determine whether eyeball tracking is enabled, at operation 324. In response to eyeball tracking being enabled, an eyeball localized ROI operation 334 is performed. For example, the eyeball localized ROI operation 334 can include determining a ROI boundary that encompasses an area of the scene in the center of the user's look direction, and a portion of the outward image data 306 corresponding to pixels within the ROI boundary can be identified as the ROI.

The operations 300 include an image-based fingertip detection operation 316 that can be performed by processing the outward image data 306 to identify whether the user's fingertip is detected in the outward image data 306. For example, detection of the user's fingertip can indicate that the user is pointing to, or engaging in a mid-air interaction with, an object of interest in the scene, or the user may be “air drawing” a boundary (e.g., a circle) around an object or region of interest to the user. For example, the image-based fingertip detection operation 316 may be performed by, or based on data from, the sensor 110 or the image sensor 112 of FIG. 1, the scene image capture operation 212 of FIG. 2, or both. A result of the image-based fingertip detection operation 316 is processed to determine whether a fingertip is detected, at operation 326. In response to a fingertip being detected, a finger localized ROI operation 336 is performed. For example, the finger localized ROI operation 336 can include determining a ROI boundary based on a point direction of the finger, based on a tracked movement of the finger drawing a boundary around an object or region of the scene, or a combination thereof, and a portion of outward image data 306 corresponding to pixels within the ROI boundary can be identified as the ROI.

The operations 300 include an image-based text detection operation 318 that can be performed, such as by processing the outward image data 306 to identify whether one or more regions of the scene include text. For example, the image-based text detection operation 318 may be performed by the ROI detector 122 or the ROI engine 124 of FIG. 1, the multimodal ROIs detector and packer 202 (e.g., the OCR module 204), or both. A result of the image-based text detection operation 318 is processed to determine whether text is detected, at operation 328. In response to text being detected, a multiple text ROI packing operation 338 is performed. For example, the multiple text ROI packing operation 338 can be performed as described for the ROI engine 124 to generate the multi-ROI canvas image 140 of FIG. 1, or as described for the multimodal ROIs detector and packer 202 to generate the multi-ROI canvas image 240 of FIG. 2, or both.

The operations 300 also include a central ROI operation 340. For example, the central ROI operation 340 can include determining a ROI boundary around a central portion of the outward image data 306, and pixels within the ROI boundary can be identified as the ROI.

The operations 300 can be performed according to an order of preference of the various modalities and include generating a final ROI or set of ROIs at a multimodal ROI operation 350 for processing at a multimodal LMM, such as the multimodal model 126, the LMM 220, or both. As illustrated, each modality is checked in order of preference, and processing proceeds to the next-most preferred modality until an available ROI detection modality is identified. In a particular embodiment, the order of preference is based on the volition of the user, such as in decreasing order of the amount of user-provided specificity associated with each modality, such that the ROI modality with highest user provided specificity (e.g., ROI identified in the user's speech) has highest preference, while the ROI modality with lowest user provided specificity (e.g., central ROI detection) has lowest preference. In the illustrated embodiment of FIG. 3A, the speech-based grounding is checked first; if speech-based grounding is not available, the eyeball tracking is checked; if eyeball tracking is not available, fingertip detection is checked; if no fingertip detection is available, text detection is checked; and if no text is detected, central ROI detection is performed.

However, in other embodiments, two or more, or all, of the ROI detection modalities may be checked independently of each other, which may result in multiple ROIs being detected via different modalities. To illustrate, one ROI may be detected based on speech-based grounding, a second ROI may be detected based on gaze tracking, a third ROI may be detected based on fingertip detection, multiple additional ROIs may be detected based on detection of multiple regions of text in the scene, and yet another ROI may be generated by the central ROI operation 340. Each of these ROIs may be arranged into a single canvas image, such as the multi-ROI canvas image 140 or the multi-ROI canvas image 240, at the multimodal ROI operation 350.

Thus, the operations 300 enable a device to obtain multimodal ROI data corresponding to the ROIs within an image based on, in some embodiments, at least one of: speech based spatial grounding associated with input speech data; gaze tracking; image-based fingertip detection associated with the image data; image-based text detection associated with the image data; or a central region of the image. In other embodiments, the multimodal ROI data can be obtained based on at least two of: speech based spatial grounding associated with input speech data; gaze tracking; image-based fingertip detection associated with the image data; image-based text detection associated with the image data; or a central region of the image, or can be obtained based on at least three of the ROI detection modalities, at least four of the detection modalities, or based on all available detection modalities. Additional examples of operations that obtain multimodal ROI data are described with reference to FIGS. 3B-E.

FIG. 3B is a diagram of an example of operations 360 that enable multi-ROI processing by a model at inference-time, in accordance with one or more aspects of the present disclosure. In some examples, one or more of the operations 360 of FIG. 3B may be performed by the processor 108 (e.g., the ROI detector 122, the model input generator 120, the ROI engine 124, or a combination thereof) of FIG. 1, the multimodal ROIs detector and packer 202 of FIG. 2, or both.

The operations 360 include, at operation 362, determining whether speech based grounding is supported. If speech based grounding is supported, the question text based spatial grounding detection operation 312 is performed on the question text 302. A result of the question text based spatial grounding detection operation 312 is processed to determine whether speech based grounding is detected, at operation 322. In response to speech based grounding being detected, the speech localized ROI operation 332 is performed.

The operations 360 include, in response to speech based grounding not being supported at operation 362, or speech based grounding not being detected, determining whether eyeball tracking is supported, at operation 364. In response to eyeball tracking being supported, the eyeball localized ROI operation 334 is performed.

The operations 360 include, in response to the eyeball tracking not being supported, determining whether fingertip grounding is supported, at operation 366. If fingertip grounding is supported, the image-based fingertip detection operation 316 is performed, and result of the image-based fingertip detection operation 316 is processed to determine whether a fingertip is detected, at operation 326. In response to a fingertip being detected, the finger localized ROI operation 336 is performed.

The operations 360 include, in response to fingertip grounding not being supported at operation 366, or fingertip grounding not being detected, determining whether text detection is supported, at operation 368. In response to text detection being supported, the image-based scene text detection operation 318 is performed, and a result of the image-based text detection operation 318 is processed to determine whether text is detected, at operation 328. In response to text being detected, the multiple text ROI packing operation 338 is performed.

In response to text detection not being supported at operation 368, or no text being detected at operation 328, the central ROI operation 340 is performed.

The operations 360 can be performed according to an order of preference of the various modalities and include generating a final ROI or set of ROIs at the multimodal ROI operation 350 for processing at a multimodal LMM, such as the multimodal model 126, the LMM 220, or both. As illustrated, each modality (other than central ROI) is checked, in order of preference, to determine if the modality is supported and, if the modality is supported, whether an ROI is indicated by the modality. Processing proceeds to the next-most preferred modality until a ROI indication by a supported modality is identified. In a particular embodiment, the order of preference is based on the volition of the user, as described above.

However, in other embodiments, two or more, or all, of the ROI detection modalities may be checked independently of each other, which may result in multiple ROIs being detected via different modalities. To illustrate, one ROI may be detected based on speech-based grounding, a second ROI may be detected based on gaze tracking, a third ROI may be detected based on fingertip detection, multiple additional ROIs may be detected based on detection of multiple regions of text in the scene, and yet another ROI may be generated by the central ROI operation 340. Each of these ROIs may be arranged into a single canvas image, such as the multi-ROI canvas image 140 or the multi-ROI canvas image 240, at the multimodal ROI operation 350.

FIG. 3C is a diagram of an example of operations 370 that enable multi-ROI processing by a model at inference-time, in accordance with one or more aspects of the present disclosure. In some examples, one or more of the operations 370 of FIG. 3C may be performed by the processor 108 (e.g., the ROI detector 122, the model input generator 120, the ROI engine 124, or a combination thereof) of FIG. 1, the multimodal ROIs detector and packer 202 of FIG. 2, or both.

The operations 370 can be performed in a device that supports a plurality of ROI detection modalities. In the illustrative example of FIG. 3C, four ROI detection modalities are supported: a first ROI detection modality, a second ROI detection modality, a third ROI detection modality, and a fourth ROI detection modality. In a non-limiting example, each of the first ROI detection modality, the second ROI detection modality, the third ROI detection modality, and the fourth ROI detection modality may correspond to one of: speech-based grounding, eyeball tracking, fingertip grounding, image-based scene text detection, or central ROI, that operate in a similar manner as described above. However, the plurality of ROI detection modalities is not necessarily limited to the listed ROI detection modalities, and in other examples the plurality of ROI detection modalities may omit one or more of the listed ROI detection modalities, may include one or more other ROI detection modalities in addition to or in place of one or more of the listed ROI detection modalities, or any combination thereof.

A preference order of the plurality of supported ROI detection modalities may be stored in a memory of the device, such as the memory 106 of FIG. 1, and the preference order may be based on an amount of user specificity associated with each ROI detection modality of the plurality of ROI detection modalities, such as described previously. In an illustrative embodiment of the preference order, speech-based grounding is preferred over eyeball tracking, which is preferred over fingertip grounding, which is preferred over image-based scene text detection, which is preferred over central ROI. As illustrated, the first ROI detection modality has a higher preference than the second ROI detection modality, which has a higher preference than the third ROI detection modality, which has a higher preference than the fourth ROI detection modality.

A first ROI detection operation 372A is performed using the first ROI detection modality to obtain a first indicator 378A of a first ROI within an image (e.g., the outward image 306). A second ROI detection operation 372B is performed using the second ROI detection modality to obtain a second indicator 378B of a second ROI within the image. A third ROI detection operation 372C is performed using the third ROI detection modality to obtain a third indicator 378C of a third ROI within the image, and a fourth ROI detection operation 372D is performed using the fourth ROI detection modality to obtain a fourth indicator 378D of a fourth ROI within the image. For example, each indicator 378 can correspond to a flag, bit, data value, or other descriptor that indicates whether one or more ROIs were detected or not detected within the image using the respective ROI detection modality.

The operations 370 include determining, at operation 374A, whether the first indicator 378A indicates that the first ROI is available. If the first indicator 378A indicates that the first ROI is available, the first ROI using the first modality is selected, at operation 376A. If the first indicator 378A does not indicate that the first ROI is available (e.g., if the first ROI is not available), the operations 370 include determining, at operation 374B, whether the second indicator 378B indicates that the second ROI is available. If the second indicator 378B indicates that the second ROI is available, the second ROI using the second modality is selected, at operation 376B. If the second indicator 378B does not indicate that the second ROI is available, the operations 370 include determining, at operation 374C, whether the third indicator 378C indicates that the third ROI is available. If the third indicator 378C indicates that the third ROI is available, the third ROI using the third modality is selected, at operation 376C. If the third indicator 378C does not indicate that the third ROI is available, the operations 370 include determining, at operation 374D, whether the fourth indicator 378D indicates that the fourth ROI is available. If the fourth indicator 378D indicates that the fourth ROI is available, the fourth ROI using the fourth modality is selected, at operation 376D. In some embodiments, one or more ROI detection modalities may always determine an available ROI (e.g., the central ROI 340), and therefore evaluation of a corresponding indicator may be omitted. The operations 370 also include generating a final ROI or set of ROIs at the multimodal ROI operation 350 for processing at a multimodal LMM, such as the multimodal model 126, the LMM 220, or both.

Thus, up to four indicators of available ROIs may be obtained. In some embodiments, one of the available ROIs is selected based on the preference order, to process at the multimodal model; in other embodiments, two or more of the available ROIs are selected, based on the preference order, to process at the multimodal model.

FIG. 3D is a diagram of an example of operations 380 that enable multi-ROI processing by a model at inference-time, in accordance with one or more aspects of the present disclosure. In some examples, one or more of the operations 380 of FIG. 3D may be performed by the processor 108 (e.g., the ROI detector 122, the model input generator 120, the ROI engine 124, or a combination thereof) of FIG. 1, the multimodal ROIs detector and packer 202 of FIG. 2, or both.

The operations 380 illustrate a variation of the operations 370 of FIG. 3C in which three ROI detection modalities are supported, as compared to the four supported ROI detection modalities illustrated in FIG. 3C. In a non-limiting example, each of the first ROI detection modality, the second ROI detection modality, and the third ROI detection modality may correspond to one of: speech-based grounding, eyeball tracking, fingertip grounding, image-based scene text detection, or central ROI, that operate in a similar manner as described above. However, the plurality of ROI detection modalities is not necessarily limited to the listed ROI detection modalities, and in other examples the plurality of ROI detection modalities may include one or more other ROI detection modalities.

A preference order of the plurality of supported ROI detection modalities may be based on an amount of user specificity associated with each ROI detection modality of the plurality of ROI detection modalities, such as described previously. In an illustrative embodiment of the preference order, speech-based grounding is preferred over eyeball tracking, which is preferred over fingertip grounding, which is preferred over image-based scene text detection, which is preferred over central ROI. As illustrated, the first ROI detection modality has a higher preference than the second ROI detection modality, which has a higher preference than the third ROI detection modality.

The ROI detection operations 372A, 372B, and 372C are performed to obtain the corresponding indicators 378A, 378B, and 378C, and the operations 374A, 374B, and 374C are performed based on the preference order until an ROI is determined to be available. Upon determining that an ROI is available, the ROI is selected at a corresponding one of the operations 376A, 376B, or 376C, and a final ROI or set of ROIs is generated at the multimodal ROI operation 350 for processing at a multimodal LMM, such as the multimodal model 126, the LMM 220, or both.

Thus, up to three indicators of available ROIs may be obtained. In some embodiments, one of the available ROIs is selected based on the preference order, to process at the multimodal model, while in other embodiments, two or more of the available ROIs are selected, based on the preference order, to process at the multimodal model.

FIG. 3E is a diagram of an example of operations 390 that enable multi-ROI processing by a model at inference-time, in accordance with one or more aspects of the present disclosure. In some examples, one or more of the operations 390 of FIG. 3E may be performed by the processor 108 (e.g., the ROI detector 122, the model input generator 120, the ROI engine 124, or a combination thereof) of FIG. 1, the multimodal ROIs detector and packer 202 of FIG. 2, or both.

The operations 390 illustrate a variation of the operations 370 of FIG. 3C in which two ROI detection modalities are supported, as compared to the four supported ROI detection modalities illustrated in FIG. 3C and the three supported ROI detection modalities illustrated in FIG. 3D. In a non-limiting example, each of the first ROI detection modality and the second ROI detection modality may correspond to one of: speech-based grounding, eyeball tracking, fingertip grounding, image-based scene text detection, or central ROI, that operate in a similar manner as described above. However, the plurality of ROI detection modalities is not necessarily limited to the listed ROI detection modalities, and in other examples the plurality of ROI detection modalities may include one or more other ROI detection modalities.

A preference order of the plurality of supported ROI detection modalities may be based on an amount of user specificity associated with each ROI detection modality of the plurality of ROI detection modalities, such as described previously. As illustrated, the first ROI detection modality has a higher preference than the second ROI detection modality.

The ROI detection operations 372A and 372B are performed to obtain the corresponding indicators 378A and 378B, and the operations 374A and 374B are performed based on the preference order until an ROI is determined to be available. Upon determining that a ROI is available, the ROI is selected at a corresponding one of the operations 376A or 376B, and a final ROI or set of ROIs is generated at the multimodal ROI operation 350 for processing at a multimodal LMM, such as the multimodal model 126, the LMM 220, or both.

Thus, up to two indicators of available ROIs may be obtained. In some embodiments, one of the available ROIs is selected based on the preference order, to process at the multimodal model, while in other embodiments, both available ROIs are selected to process at the multimodal model.

FIGS. 4-6 depict examples of techniques in which multiple ROIs have been detected, including one or more text-based ROIs that are identified by performing text detection in a scene image, and image representations of the ROIs are inserted into a canvas image with at least a threshold separation distance between each of the image representations. To illustrate, the threshold separation distance can be a minimum pixel distance between the image representations so that the visual tokens from adjacent ROIs in the canvas image do not overlap. As an example, the threshold separation distance can be higher for CNN-based visual encoding which has a larger receptive field and smaller for CLIP-ViT based visual encoding. Although the ROIs in the following examples are illustrated as rectangular, the ROIs need not be rectangular and can instead have any other shape or can be arbitrarily shaped.

Referring to FIG. 4, a diagram of a first example of arranging multiple ROIs into a canvas image for processing by a model at inference-time is illustrated, in accordance with one or more aspects of the present disclosure. A scene image 400 depicts a scene and may correspond to the image data 113 or the scene image data 230A, as illustrative, non-limiting examples. Four text-based ROIs 402, 404, 406, and 408 are detected in the scene image 400, with boundary boxes illustrated by solid white borders around each of the ROIs 402-408. The canvas image 410 includes an image representation of each of the four detected ROIs of the scene image 400, including an image representation 412 of the ROI 402, an image representation 414 of the ROI 404, an image representation 416 of the ROI 406, and an image representation 418 of the ROI 408. The canvas image 410 may by generated by a multi-ROI packing device, such as the multi-ROI canvas image 140 generated by the ROI engine 124 of FIG. 1 or the multi-ROI canvas image 240 generated by the multimodal ROIs detector and packer 202 of FIG. 2, as illustrative, non-limiting examples.

The image representations 412-418 of the ROIs 402-408 are arranged in the canvas image 410 according to a first technique in which the image representations 412-418, sorted from largest to smallest, are inserted into the canvas image 410 in a raster scan order with at least a threshold separation distance 430 between each of the image representations 412-418. The image representations 412-418 of the multiple ROIs 402-408 are based on patches of the scene image 400 that correspond to the multiple ROIs (e.g., the pixel data for pixels within the respective boundary boxes) scaled according to a scaling factor, where the scaling factor is based on a total area of the multiple ROIs 402-408, as described further below.

A flowchart 450 illustrates an example of a process that may be used by the ROI packing module to sort, scale, and arrange image representations of ROIs into a canvas image. As shown in the flowchart 450, the ROI boundary boxes are sorted based on the raster scan order of the top left coordinate of each of the boundary boxes in a scene image, at operation 452. For example, the boundary boxes of the ROIs 402-408 are sorted based on the raster scan order of the top left coordinate of the boundary boxes in the scene image 400. A sum of the area of all of the ROIs (e.g., the sum of the area of the boundary box each of the ROIs 402-408) is calculated, at operation 454.

A determination is made as to whether the combined area of the ROIs exceeds the area of the canvas image, at operation 456. In response to the total area of the ROIs exceeding the canvas area, the ROIs are sorted in descending order of area, and the N largest ROIs are selected for inclusion into the canvas image such that the total sum of the areas of the N largest ROIs is less than the canvas area, at operation 458. For example, based on the total area of the ROIs exceeding the area of the canvas image, the largest positive integer N (where N is less than or equal to the number of ROIs in the scene) is determined such that, when the N largest ROIs are included and one or more of the smallest of the ROIs are excluded from the canvas image, the image representations of the N remaining ROIs, separated by the threshold separation distance, fit within the canvas image.

An occupancy metric for the ROIs is determined, at operation 460. According to an aspect, the occupancy factor corresponds to a ratio of the total area of the ROIs to an area of the canvas image. As an illustrative, non-limiting example, the occupancy metric can be determined as:

$$Occupancy = {\sum }_{i = 1}^{N} \frac{( {ROI\_width}^{i} + margin ) * ( max\_ROI \_height + margin )}{Canvas Area} ,$$

where ROI_widthⁱ is the width of the ith ROI, margin is the smallest allowable separation distance between the ROIs, max_ROI_height is the largest vertical dimension of the ROIs, and N is the number of ROIs to be inserted into the canvas image. Using the scene image 400 and canvas image 410 as a particular example, margin corresponds to the threshold separation distance 430, max_ROI_height corresponds to the height of the ROI 402, and Canvas Area corresponds to the area of the canvas image 410.

A scaling factor is determined, at operation 462. For example, when the image representations 412-418 of the ROIs 402-408 occupy a relatively small portion of the canvas image 410, the scaling factor may be selected to increase the size of the image representations, enabling greater detail of each ROI to be included in the canvas image 410, via increased pixel density, and resulting in improved accuracy. In an illustrative, non-limiting example, the scaling factor is obtained based on a comparison of an occupancy factor to one or more occupancy thresholds. To illustrate, the scaling factor may be obtained based on occupancy thresholds of 0.1, 0.15, and 0.2 according to the pseudocode:

If occupancy <= 0.1, then scale = 2;
else if occupancy <= 0.15, then scale = 1.5;
else if occupancy <= 0.2, then scale = 1.2;
else scale = 1.

The ROIs are scaled based on the scaling factor, at operation 464, and the ROIs are packed into the canvas image using a fixed margin, at 466. To illustrate, the image representations 412-418 of the ROIs 402-408 are arranged in raster scan order, from largest to smallest, in the canvas image 410 and have at least the threshold separation distance 430 in both the vertical direction and the horizontal direction between each of the image representations 412-418.

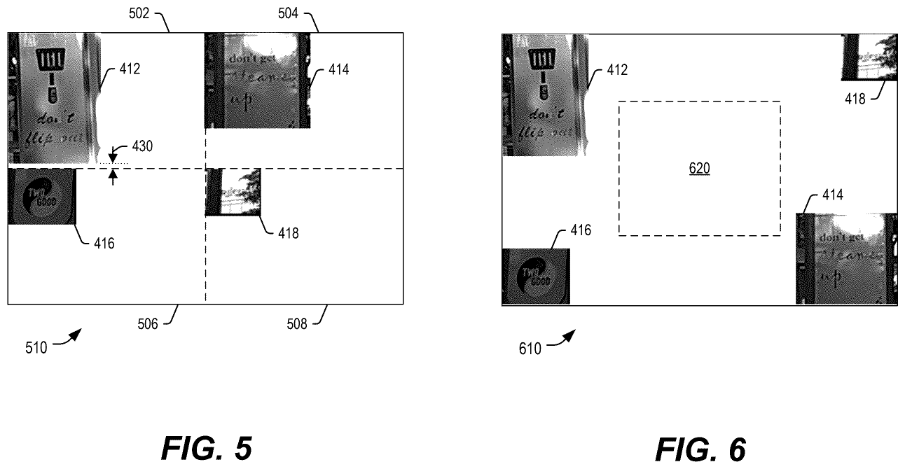

Referring to FIG. 5, a diagram of a second example of arranging multiple ROIs into a canvas image 510 for processing by a model at inference-time is illustrated, in accordance with one or more aspects of the present disclosure. The canvas image 510 may by generated by a multi-ROI packing device and may correspond to the multi-ROI canvas image 140 generated by the ROI engine 124 of FIG. 1 or the multi-ROI canvas image 240 generated by the multimodal ROIs detector and packer 202 of FIG. 2, as illustrative, non-limiting examples.

As illustrated, the canvas image 510 is divided into a grid of equally-sized grid cells 502, 504, 506, and 508. A number of the grid cells 502-508 is selected to match or exceed a number of the ROIs. According to an aspect, the grid is a regular square grid having N rows and N columns, where N is selected as a smallest integer value for which N² is greater than or equal to the number of the ROIs. Using the scene image 400 as an example, because four ROIs 402, 404, 406, and 408 are identified, N is selected to have a value of 2, which is the smallest integer value such that N² (e.g., 4) is greater than or equal to the number of ROIs (e.g., 4).

The image representations 412, 414, 416, and 418 of the ROIs 402, 404, 406, and 408, respectively, are obtained based on patches of the image data (e.g., the scene image 400) corresponding to the ROIs 402-408. According to an aspect, each of the image representations 412-418 is selectively scaled based on a grid cell size and a threshold separation distance. For example, each of the image representations 412-418 may be scaled (e.g., upscaled to have a larger size or downscaled to have a smaller size) so that the image representation fits within its respective grid cell with at least the threshold separation distance 430 between the image representation and each adjacent grid cell. In some examples, a single scaling factor is applied to each of the image representations, while in other examples each of the image representations may be scaled independently of the other image representations.

According to an aspect, each of the image representations 412-418 is inserted into a respective grid cell with at least the threshold separation distance 430 between each of the image representations. In some examples, a respective destination grid cell for the image representation of each particular ROI is selected based on a similarity of a first location of the particular ROI (e.g., a center point of the ROI) within the scene image to a second location (e.g., a center point) of the respective destination grid cell within the canvas image. For example, a ROI in the upper let of the scene image would map to the upper left grid cell in the canvas image. If two ROIs map to the same grid cell, the smaller of the two ROIs can be reassigned to an adjacent cell. In a particular embodiment, a respective destination grid cell is selected for the image representation of each particular ROI based on distance between a center of each particular ROI within the image and a center of the destination grid cell and, based on two of the ROIs being mapped to a single destination grid cell, the larger of the two ROIs is allocated to the single destination grid cell, and the smaller of the two ROIs is assigned to an adjacent grid cell. In other examples, the image representations of the ROIs are assigned to respective grid cells based on one or more other criteria, such as according to the size of the respective ROIs in the scene image.

Although the image representations 412-418 are illustrated as positioned at the upper left corner of their respective grid cells, in other embodiments the image representations 412-418 may have a different positioning in the grid cells, such as at another corner or at the center of the grid cells, as illustrative, non-limiting examples.

FIG. 6 is a diagram of a third example of arranging multiple ROIs into a canvas image 610 for processing by a model at inference-time, in accordance with one or more aspects of the present disclosure. The canvas image 610 may by generated by a multi-ROI packing device and may correspond to the multi-ROI canvas image 140 generated by the ROI engine 124 of FIG. 1 or the multi-ROI canvas image 240 generated by the multimodal ROIs detector and packer 202 of FIG. 2, as illustrative, non-limiting examples.

Image representations of ROIs are inserted into the canvas image 610 according to a packing process that includes (1) inserting the four largest image representations of ROIs into respective corners of the canvas image 610, (2) inserting the next four largest image representations at the midpoint of each edge of the canvas image 610, and (3) inserting remaining image representations into a central rectangular region 620 of the canvas image 610. Using the image representations 412-418 of the ROIs 402-408 from the scene image 400 of FIG. 4 as an example, each of the four image representations 412, 414, 416, and 418 is depicted in a respective corner of the canvas image 610, and since the scene image 400 only includes four ROIs, no image representations are included at the midpoint along the canvas edges, or in the central region 620.

In one implementation, after the eight largest ROIs are placed around the periphery of the canvas image, each of the remaining image representations, sorted from largest to smallest, are inserted into the central rectangular region 620 in a raster scan order with at least a threshold separation distance 430 between each of the remaining image representations, in a similar manner as described in the first example depicted in FIG. 4. In another implementation, after the eight largest ROIs are placed around the periphery of the canvas image 610, the central rectangular region 620 is divided into a grid, and each of the remaining image representations are inserted into a respective grid cell and selectively scaled to obtain at least the threshold separation distance 430 between each of the remaining image representations in the grid, in a similar manner as described in the second example depicted in FIG. 5.

The examples provided in FIGS. 4, 5, and 6 offer various advantages. For example, the technique described in FIG. 4 is relatively quick due to its procedural and deterministic nature, and scaling of ROIs can be performed on-the-fly to accommodate a maximum number of ROIs on the canvas image, although this technique can be less flexible in terms of scaling factors and margins in between individual ROIs. The technique described in FIG. 5 is also relatively quick due to its procedural and deterministic nature, although if a ROI has to be scaled down to fit the grid size it can lead to reduced image clarity for that ROI. The technique described in FIG. 6 ensures the least interference among the ROIs, but may not be the most optimal for larger numbers of ROIs. According to an illustrative, non-limiting example, a system (e.g., the ROI engine 124) can perform a selection of one of the techniques of FIGS. 4-6 according to the following criteria: (1) use the technique of FIG. 4 when the number of ROIs is 6 or fewer and the largest ROI size is less than 25% of the canvas size, (2) else, use the technique of FIG. 6 if any ROI exceeds 25% of the canvas size and the number of ROIs is 6 or fewer, (3) else, use the technique described in FIG. 5.

FIG. 7 is a block diagram of an example of a multimodal model that supports inference-time multi-ROI processing, in accordance with one or more aspects of the present disclosure. In some examples, the multimodal model 700 may include or correspond to the multimodal model 126 of FIG. 1, the LMM 220 of FIG. 2, or both. In some embodiments, the multimodal model 700 includes or corresponds to an LMM, particularly an “off-the-shelf” or pretrained LMM that is not trained or fine-tuned to focus on particular portions or features of images. Conventional LMMs (e.g., off-the-shelf LMMs) typically accept an image-question pair and output an answer to the question, but are not designed to accept multiple user-defined ROIs simultaneously.

In the example depicted in FIG. 7, the multimodal model 700 includes an image encoder 702, a pruner 720, a mapper 704, a text encoder 706, and a language model 708. In an illustrative example, the image encoder 702, the mapper 704, the text encoder 706, and the language model 708 correspond to the image encoder 142, the mapper 144, the text encoder 146, and the LLM 148, respectively, of FIG. 1. In another illustrative example, the image encoder 702, the pruner 720, the mapper 704, the text encoder 706, and the language model 708 correspond to the image encoder 242, the token pruner 260, the mapper 244, the text encoder 246, and the LLM decoder 248, respectively, of FIG. 2. Although illustrated in FIG. 7 as separate components, the image encoder 702, the pruner 720, and the mapper 704 may alternatively be integrated together as an image encoding and mapping model. The image encoder 702 is configured to generate image tokens that represent image(s) or image features, and the image tokens may be in the form of text data or text features (e.g., the image encoder 702 performs image-to-text encoding). In some embodiments, the image encoder 702 may be trained using contrastive learning or next-token prediction.

The pruner 720 is configured to omit, from the input to the mapper 704, one or more image tokens that are generated by processing a multi-ROI canvas image 750 at the image encoder 702 and that do not correspond to any of the ROIs. An example of the multi-ROI canvas image 750 is graphically depicted as including the four image representations 412-416 of the ROIs 402-408 of FIG. 4, with an overlaid grid of cells that correspond to individual tokens. Cells that may be omitted by the pruner 720 are illustrated as having gray dots. For example, the system (e.g., the image encoder 702 or the pruner 720) can identify one or more regions of the multi-ROI canvas image 750 that, after arrangement of the image representations 412-418 into the multi-ROI canvas image 750, do not correspond to any of the image representations 412-418. To illustrate, unused portions of the multi-ROI canvas image 750 after insertion of the image representations 412-418 according to the raster scan order of FIG. 4, unused grid cells of FIG. 5, or unused placement areas in FIG. 6, can be identified, and image tokens associated with the image encoder cells within the unused portions of the multi-ROI canvas image 750 can be excluded by the token pruner 720 and omitted from the input to the mapper 704. Because the complexity of a multi-headed attention in the language model 708 varies quadratically with the number of tokens, pruning tokens of regions of the multi-ROI canvas image 750 where there is no information can improve the speed of operation of the language model 708.

The mapper 704 is configured to map the image tokens output by the pruner 720 (or by the image encoder 702 in embodiments in which the pruner 720 is omitted) to a common token space that is associated with the text encoder 706. For example, the mapper 704 may be configured to generate a first sequence of image tokens in a common token space (e.g., first feature data). The text encoder 706 may be configured to map input text data (or text features) that represent a query, or other information, into a common token space with the output of the mapper 704. For example, the text encoder 706 may be configured to generate a second sequence of question tokens (e.g., second feature data) based on input text data (or text features), and the first and second token streams may be in the same token space.

The language model 708 is configured to receive a sequence of tokens as input (e.g., a concatenation of the first feature data output by the mapper 704 and the second feature data output by the text encoder 706) and to generate a response to a question represented by the input token stream and based at least partly on an image indicated by the input token stream. In some embodiments, the language model 708 includes or corresponds to an LLM. As can be appreciated, the combination of the image encoder 702, pruner 720, the mapper 704, the text encoder 706, and the language model 708 can be considered as a simplified black-box interface that receives a question, a canvas image that includes multiple ROIs, and potentially other image data, and that outputs an answer to the question.

During operation, the multimodal model 700 may receive model input data 710 that includes image related data 712 and text data 714. In some examples, the model input data 710 includes or corresponds to the model input data 132 of FIG. 1 or a combination of the question text data 236, the multi-ROI canvas image 240, the global context image data 234, and optionally image tile data, as described with reference to FIG. 2. The model input data 710 may represent an image, multiple ROIs within the image, and a query (e.g., a question) that is to be answered at least partially based on the image and the ROIs. For example, the image related data 712 may include a global context image and a multi-ROI canvas image, and the text data 714 may include text that represents a query. The image related data 712 is provided to the image encoder 702 for encoding into image tokens (e.g., to text data) and subsequently to the mapper 704, via the pruner 720, for generation of first feature data (e.g., a first sequence of tokens). The text data 714 is provided to the text encoder 706 for generation of second feature data (e.g., a second sequence of tokens). The first feature data and the second feature data may be combined (e.g., flattened and concatenated) and provided as input to the language model 708, and the language model 708 may generate a response output 716 that represents an answer to the query represented by the model input data 710. For example, the response output 716 may include or correspond to the response output 138 of FIG. 1, the response output 250 of FIG. 2, or both.

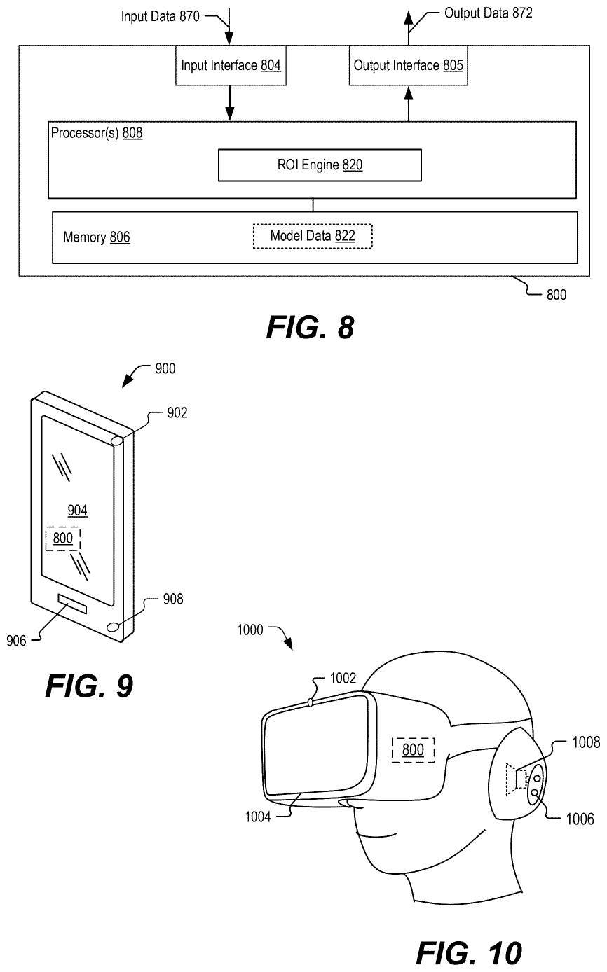

FIG. 8 depicts a diagram of an example of an integrated circuit 800 operable to enable multi-ROI processing by a model at inference-time, in accordance with some examples of the present disclosure. The integrated circuit 800 includes one or more processors 808 (herein after referred to as the “processor 808”) and a memory 806. The processor 808 and the memory 806 may include or correspond to the processor 108 and the memory 106, respectively. The processor 808 may include an ROI engine 820. The ROI engine 820 may include or correspond to the ROI engine 124, one or more of the components 200, or a combination thereof. In some examples, the memory 806 includes (e.g., stores) model data 822, which may include or correspond to the model data 130, and the processor 808 is configured to implement the multimodal model 126, the LMM 220, or the multimodal model 700. Alternatively, output generated by the ROI engine 820 may be provided to another device or component that implements a multimodal model. Additionally, or alternatively, the processor 808 may include the model input generator 120, the ROI detector 122, one or more of the components 200, or a combination thereof (not shown), in examples in which the integrated circuit 800 is configured to generate model input data or to detect multiple ROIs in image data.

The integrated circuit 800 also includes an input interface 804, such as one or more bus interfaces, to enable the integrated circuit 800 to receive input data 870 for processing. For example, the input data 870 can correspond to or include the sensor data 111, the image data 113, the input data 115, the model input data 132, the boundary data 134, the image data 230, the audio data 232, the global context image data 234, the question text data 236, the question text 302, the outward image data 306, the model input data 710, or a combination thereof. The integrated circuit 800 also includes an output interface 805, such as a bus interface, to enable the integrated circuit 800 to generate output data 872. For example, the output data 872 can correspond to or include the model input data 132, the response output 138, the multi-ROI canvas image 240, the response output 250, the response output 716, or a combination thereof.

The integrated circuit 800 including the ROI engine 820 enables implementation of multi-ROI processing by a model at inference-time as a component in a system or a device. For example, the system or the device may include a mobile device (e.g., a mobile phone or tablet) as depicted in FIG. 9, a virtual reality, mixed reality, or augmented reality headset as depicted in FIG. 10, a wearable electronic device as depicted in FIG. 11, a voice-controlled speaker system as depicted in FIG. 12, a camera as depicted in FIG. 13, or a vehicle as depicted in FIG. 14.

In some embodiments, the system or the device that includes the integrated circuit 800 also includes or is coupled to an image sensor (e.g., a camera), an input device (e.g., a microphone, a keyboard or touch screen, etc.), a display device, a speaker, a modem, or a combination thereof. For example, the image sensor, the input device, the display device, the speaker, and the modem may include or correspond to the image sensor 112, the input device 114, the display device 116, the speaker 117, and the modem 118, respectively.

FIG. 9 depicts a diagram of a mobile device 900 operable to enable multi-ROI processing by a model at inference-time, in accordance with some examples of the present disclosure. The mobile device 900 may include or correspond to a phone or a tablet, as illustrative, non-limiting examples. The mobile device 900 includes a camera 902 (e.g., an image sensor), a display 904 (e.g., a display screen), a microphone 906, a speaker 908, and the integrated circuit 800. Components of the integrated circuit 800, including the ROI engine 820, are integrated in the mobile device 900 and are illustrated using dashed lines to indicate internal components that are not generally visible to a user of the mobile device 900.

In a particular example, the ROI engine 820 is operable to select one or more ROIs associated with various ROI detection modalities according to a preference order, such as described with reference to one or more of FIGS. 3A-3E. For example, user speech may be captured using the microphone 906 and processed for speech based grounding, gaze tracking may be performed based on processing image data captured by the front camera 902, and one or more of fingertip grounding, scene text detection, or central ROI may be performed based on processing image data captured by a rear camera of the mobile device 900.

In a particular example, the ROI engine 820 is operable to obtain image data representing images or video captured by the camera 902, from another device, or from an application executed by the mobile device 900, to generate model input data for a model, and to generate a multi-ROI canvas image of ROIs detected in an image represented by the image data. Generation of a multi-ROI canvas image enables the mobile device 900 to support multi-ROI processing by the model at inference-time.

FIG. 10 is a diagram of a headset 1000, such as a virtual reality, mixed reality, or augmented reality headset or a virtual reality, mixed reality, or augmented reality glasses device, operable to enable multi-ROI processing by a model at inference-time, in accordance with some examples of the present disclosure. A visual interface device is positioned in front of the user's eyes to enable display of augmented reality, mixed reality, or virtual reality images or scenes to the user while the headset 1000 is worn. The headset 1000 also includes a camera 1002 (e.g., an image sensor), a display 1004 (e.g., a display screen), a microphone 1006, a speaker 1008, and the integrated circuit 800. Components of the integrated circuit 800, including the ROI engine 820, are integrated in the headset 1000 and are illustrated using dashed lines to indicate internal components that are not generally visible to a user of the headset 1000.

In a particular example, the ROI engine 820 is operable to select one or more ROIs associated with various ROI detection modalities according to a preference order, such as described with reference to one or more of FIGS. 3A-3E. For example, user speech may be captured using the microphone 1006 and processed for speech based grounding, gaze tracking may be performed via processing image data captured by one or more inward facing cameras of the headset 1000, and one or more of fingertip grounding, scene text detection, or central ROI may be performed based on processing image data captured by the camera 1002.

In a particular example, the ROI engine 820 is operable to obtain image data representing images or video captured by the camera 1002, from another device, or from an application executed by the headset 1000, to generate model input data for a model, and to generate a multi-ROI canvas image of ROIs detected in an image represented by the image data. Generation of a multi-ROI canvas image enables the headset 1000 to support multi-ROI processing by the model at inference-time.

FIG. 11 depicts a diagram of a wearable electronic device 1100 operable to enable multi-ROI processing by a model at inference-time, in accordance with some examples of the present disclosure. The wearable electronic device 1100 may include or correspond to a “smart watch,” as an illustrative, non-limiting example. The wearable electronic device 1100 includes a camera 1102 (e.g., an image sensor), a display 1104 (e.g., a display screen), a microphone 1106, a speaker 1108, and the integrated circuit 800. Components of the integrated circuit 800, including the ROI engine 820, are integrated in the wearable electronic device 1100 and are illustrated using dashed lines to indicate internal components that are not generally visible to a user of the wearable electronic device 1100.

In a particular example, the ROI engine 820 is operable to select one or more ROIs associated with various ROI detection modalities according to a preference order, such as described with reference to one or more of FIGS. 3A-3E. For example, user speech may be captured using the microphone 1106 and processed for speech based grounding, and one or more of fingertip grounding, scene text detection, or central ROI may be performed based on processing image data captured by the camera 1102.

In a particular example, the ROI engine 820 is operable to obtain image data representing images or video captured by the camera 1102, from another device, or from an application executed by the wearable electronic device 1100, to generate model input data for a model, and to generate a multi-ROI canvas image of ROIs detected in an image represented by the image data. Generation of a multi-ROI canvas image enables the wearable electronic device 1100 to support multi-ROI processing by the model at inference-time.

FIG. 12 is a diagram of a voice-controlled speaker system 1200 operable to enable multi-ROI processing by a model at inference-time, in accordance with some examples of the present disclosure. The voice-controlled speaker system 1200 may include or correspond to a wireless speaker and voice activated device, as an illustrative, non-limiting example. The voice-controlled speaker system 1200 can have wireless network connectivity and is configured to execute an assistant operation. The voice-controlled speaker system 1200 includes a camera 1202 (e.g., an image sensor), a display 1204 (e.g., a display screen), a microphone 1206, a speaker 1208, and the integrated circuit 800. Components of the integrated circuit 800, including the ROI engine 820, are integrated in the voice-controlled speaker system 1200 and are illustrated using dashed lines to indicate internal components that are not generally visible to a user of the voice-controlled speaker system 1200.

In a particular example, the ROI engine 820 is operable to select one or more ROIs associated with various ROI detection modalities according to a preference order, such as described with reference to one or more of FIGS. 3A-3E. For example, user speech may be captured using the microphone 1206 and processed for speech based grounding, gaze tracking may be performed based on processing image data captured by a user-facing camera of the voice-controlled speaker system 1200, and one or more of fingertip grounding, scene text detection, or central ROI may be performed based on processing image data captured by a scene-facing camera of the voice-controlled speaker system 1200.

In a particular example, the ROI engine 820 is operable to obtain image data representing images or video captured by the camera 1202, from another device, or from an application executed by the voice-controlled speaker system 1200, to generate model input data for a model, and to generate a multi-ROI canvas image of ROIs detected in an image represented by the image data. Generation of a multi-ROI canvas image enables the voice-controlled speaker system 1200 to support multi-ROI processing by the model at inference-time.

FIG. 13 is a diagram of a camera device 1300 operable to enable multi-ROI processing by a model at inference-time, in accordance with some examples of the present disclosure. The camera device 1300 includes an image sensor 1302, a display 1304 (e.g., a display screen), a microphone 1306, a speaker 1308, and the integrated circuit 800. Components of the integrated circuit 800, including the ROI engine 820, are integrated in the camera device 1300 and are illustrated using dashed lines to indicate internal components that are not generally visible to a user of the camera device 1300.

In a particular example, the ROI engine 820 is operable to select one or more ROIs associated with various ROI detection modalities according to a preference order, such as described with reference to one or more of FIGS. 3A-3E. For example, user speech may be captured using the microphone 1306 and processed for speech based grounding, gaze tracking may be performed based on processing image data captured by a user-facing camera of the camera device 1300, and one or more of fingertip grounding, scene text detection, or central ROI may be performed based on processing image data captured by the image sensor 1302.

In a particular example, the ROI engine 820 is operable to obtain image data representing images or video captured by the image sensor 1302, from another device, or from an application executed by the camera device 1300, to generate model input data for a model, and to generate a multi-ROI canvas image of ROIs detected in an image represented by the image data. Generation of a multi-ROI canvas image enables the camera device 1300 to support multi-ROI processing by the model at inference-time.

FIG. 14 is a diagram of an example of a vehicle 1400 operable to enable multi-ROI processing by a model at inference-time, in accordance with some examples of the present disclosure. The vehicle 1400 may include or correspond to a car. The vehicle 1400 includes one or more cameras 1402 (e.g., one or more outward-facing image sensors, one or more interior-facing image sensors, or a combination thereof), a display 1404 (e.g., a display screen), a microphone 1406, one or more speakers 1408, and the integrated circuit 800. Components of the integrated circuit 800, including the ROI engine 820, are integrated in the vehicle 1400 and are illustrated using dashed lines to indicate internal components that are not generally visible to a user of the vehicle 1400.

In a particular example, the ROI engine 820 is operable to select one or more ROIs associated with various ROI detection modalities according to a preference order, such as described with reference to one or more of FIGS. 3A-3E. For example, user speech may be captured using the microphone 1406 and processed for speech based grounding, gaze tracking may be performed based on processing image data captured by a user-facing camera 1402, and one or more of fingertip grounding, scene text detection, or central ROI may be performed based on processing image data captured by a scene-facing (e.g., outward-facing) camera 1402.

In a particular example, the ROI engine 820 is operable to obtain image data representing images or video captured by the camera 1402, from another device, or from an application executed by the vehicle 1400, to generate model input data for a model, and to generate a multi-ROI canvas image of ROIs detected in an image represented by the image data. Generation of a multi-ROI canvas image enables the vehicle 1400 to support multi-ROI processing by the model at inference-time.

According to an aspect, each of the embodiments of the systems or devices as described with reference to FIGS. 8-14 may correspond to, include, or be included in, the system 100 and/or the device 102 or FIG. 1. The embodiments of the systems or devices as described with reference to FIGS. 9-14 are described, respectively, as including a display, a microphone, a speaker, a camera, or a combination thereof. As described with reference to FIGS. 9-14, the display, the microphone, the speaker, the camera may include or correspond to the display device 116, the input device 114, the speaker 117, and the image sensor 112, respectively. It is noted that in other embodiments of the systems or devices of FIGS. 9-14, one or more of the systems or devices of FIGS. 9-14 may not include the display, the microphone, the speaker, the camera, or a combination thereof. Additionally, or alternatively, one or more of the systems or devices of FIGS. 9-14 may include an additional component. For example, the additional component may include a modem, such as the modem 118, or a sensor, such as the sensor 110.

FIG. 15 is a diagram of an example of a method 1500 of enabling multi-ROI processing by a model at inference-time, in accordance with some aspects of the present disclosure. In a particular aspect, one or more operations of the method 1500 are performed by the system 100, the device 102, the processor 108, the model input generator 120, the ROI detector 122, the ROI engine 124, the multimodal model 126, the components 200, the multimodal model 700, the integrated circuit 800, the ROI engine 820, the mobile device 900, the headset 1000, the wearable electronic device 1100, the voice-controlled speaker system 1200, the camera device 1300, the vehicle 1400, or a combination thereof.

In some embodiments, the method 1500 includes, at block 1502, obtaining image data representing an image. For example, the model input generator 120 may obtain the image data 113 that represents an image. The method 1500 also includes, at block 1504, obtaining data representing multiple regions of interest (ROIs) within the image, the multiple ROIs including one or more ROIs that include text. For example, the model input generator 120, the ROI engine 124, or both may obtain the image data 113 from which multiple ROIs that include text are detected, the model input generator 120 (and optionally the ROI detector 122) may obtain the input data 115 that indicates one or more ROIs within the image, and/or the ROI detector 122 may obtain the sensor data 111 that represents one or more ROIs. In some embodiments, the input data 115 also indicates a query, and the model input generator 120 obtains the input data 115 that represents the query.

The method 1500 further includes, at block 1506, arranging image representations of the ROIs into a single canvas image. For example, the ROI engine 124 may arrange the image representations into the multi-ROI canvas image 140, such as by using one or more of the techniques described with respect to FIG. 4, FIG. 5, or FIG. 6. The method 1500 includes, at block 1508, inputting the canvas image into an image encoder of a multimodal model to obtain image tokens associated with cells of the canvas image. For example, the multi-ROI canvas image 140 is input into the image encoder 142 of the multimodal model 126.

The method 1500 includes, at block 1510, providing a first input to a large language model (LLM) of the multimodal model, the first input based on the image tokens, to generate a response output. For example, in various embodiments, the image tokens output by the image encoder 142, a pruned set of the image tokens output by the image encoder 142, or a set of image tokens in text space that are output by the mapper 144, are provided as a first input to the LLM 148 and processed, in conjunction with an output of the text encoder 146 (e.g., a second input to the LLM 148), to generate the response output 138.

In some embodiments, arranging the image representations of the multiple ROIs into the canvas image includes obtaining the image representations of the multiple ROIs based on patches of the image data corresponding to the multiple ROIs scaled according to a scaling factor, where the scaling factor is based on a total area of the multiple ROIs. For example, the image representations 412-418 of the multiple ROIs 402-408 depicted in FIG. 4 are obtained based on patches of the scene image 400 and a scaling factor determined in operation 462 of FIG. 4. In such embodiments, arranging the representations of the multiple ROIs into the canvas image also includes inserting the image representations of the ROIs, sorted from largest to smallest, into the canvas image in a raster scan order with at least a threshold separation distance between each of the image representations, such as depicted in the multi-ROI canvas image 410.

In some embodiments, arranging the image representations of the ROIs into the canvas image includes dividing the canvas image into a grid of equally-sized grid cells, where a number of the grid cells is selected to match or exceed a number of the ROIs, such as described with reference to the grid cells 502-508 of the multi-ROI canvas image 510 of FIG. 5. In such embodiments, arranging the image representations of the ROIs into the canvas image also includes obtaining the image representations of the ROIs based on patches of the image data corresponding to the ROIs, where each of the image representations is selectively scaled based on a grid cell size and a threshold separation distance, and inserting each of the image representations into a respective grid cell with at least the threshold separation distance between each of the image representations, such as described with reference to inserting each of the image representations 412-418 into the respective grid cells 502-508 of FIG. 5.

In some embodiments, arranging the image representations of the ROIs into the canvas image includes obtaining the image representations of the ROIs based on patches of the image data corresponding to the ROIs, and inserting the image representations into the canvas image with at least a threshold separation distance between each of the image representations and according to a packing process that includes insertion of the four largest image representations into respective corners of the canvas image. For example, the image representations 412-416 are inserted into the respective corners of the multi-ROI canvas image 610. The packing process also includes insertion of the next four largest image representations at the midpoint of each edge of the canvas image, and insertion of remaining image representations into a central rectangular region of the canvas image, such as the central region 620 of the multi-ROI canvas image 610.

In some embodiments, the method 1500 includes generating a pruned set of the image tokens corresponding to the canvas image by removing one or more of the image tokens that do not correspond to any of the ROIs, and the first input to the LLM is based on the pruned set of the image tokens. For example, the pruner 720 omits, from the input to the mapper 704, one or more of the image tokens that are generated by processing a multi-ROI canvas image 750 at the image encoder 702 and that do not correspond to any of the detected ROIs.

In some embodiments, the method 1500 includes identifying the one or more ROIs that include text based on detection of text in the image. For example, the processor 108 identifies one or more ROIs that include text based on detection of text, such as by performing text detection processing of the image data 113 at the ROI detector 122 and/or at the ROI engine 124 to detect regions within the image that include text.

In some embodiments, the method 1500 includes obtaining data corresponding to a query, processing the data corresponding to the query to generate question tokens and providing the question tokens as a second input to the LLM, and the response output corresponds to a response to the query. For example, the input data 115 generated by the input device 114 may represent a query (e.g., a question) to be answered by the multimodal model 126, which is processed by the text encoder 146 to generate question tokens that are input to the LLM 148, and the response output 138 may correspond to a response to the query.

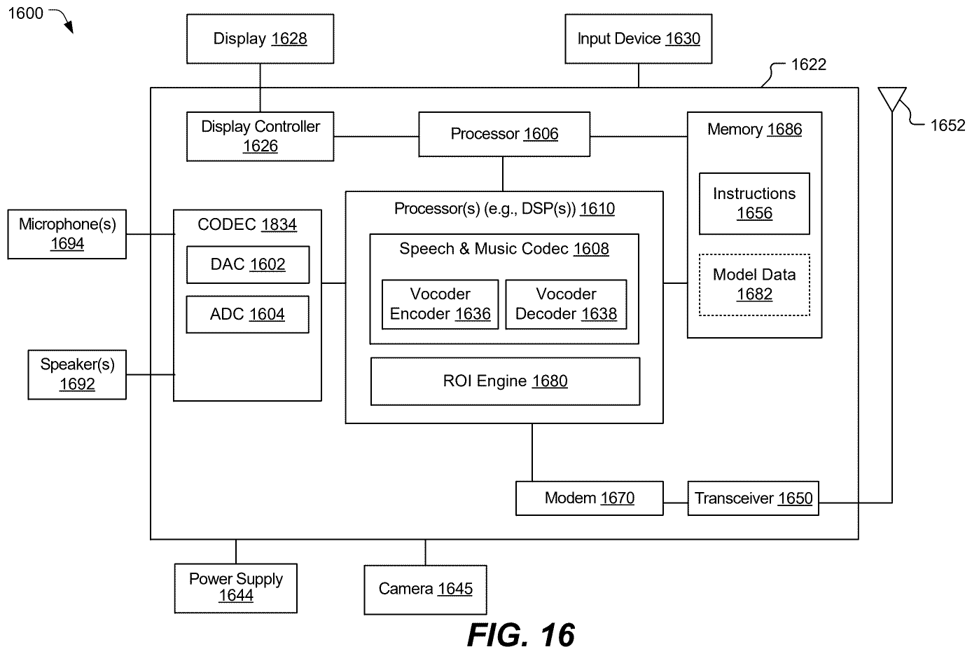

The method 1500 of FIG. 15 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1500 of FIG. 15 may be performed by a processor that executes instructions, such as described with reference to FIG. 16.

It is noted that one or more blocks (or operations) described with reference to FIG. 15 may be combined with one or more blocks (or operations) described with reference to another of the figures. For example, one or more blocks associated with FIG. 15 may be combined with one or more blocks (or operations) associated with FIGS. 1-14. Additionally, or alternatively, one or more operations described above with reference to FIGS. 1-15 may be combined with one or more operations described with reference to FIG. 16.

FIG. 16 is a block diagram of an illustrative example of a device 1600 that is operable to enable multi-ROI processing by a model at inference-time, in accordance with one or more aspects of the present disclosure. In various implementations, the device 1600 may have more or fewer components than illustrated in FIG. 16. In an illustrative implementation, the device 1600 may correspond to the device 102. In an illustrative implementation, the device 1600 may perform one or more operations described with reference to FIGS. 1-15.

In a particular implementation, the device 1600 includes a processor 1606 (e.g., a central processing unit (CPU)). The device 1600 may include one or more additional processors 1610 (e.g., one or more DSPs). In a particular aspect, the processor 108 of FIG. 1 or the processor 808 of FIG. 8 corresponds to the processor 1606, the processor(s) 1610, or a combination thereof. The processor(s) 1610 may include a speech and music coder-decoder (CODEC) 1608 that includes a voice coder (“vocoder”) encoder 1636, a vocoder decoder 1638, an ROI engine 1680, or a combination thereof. The ROI engine 1680 may include or correspond to the ROI engine 124, one or more of the components 200, the ROI engine 820, or a combination thereof.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 1600 may include a memory 1686 and a CODEC 1634. The memory 1686 may include or correspond to the memory 106 or the memory 806. The memory 1686 may include instructions 1656, that are executable by the one or more additional processors 1610 (or the processor 1606) to implement the functionality described with reference to the ROI engine 1680, or both. The instructions 1656 may include or correspond to the instructions 109. The memory 1686 optionally includes model data 1682. The model data 1682 may include or correspond to the model data 130 or the model data 822, and the model data 1682 may be used to implement the multimodal model 126, the LMM 220, or the multimodal model 700. The device 1600 may include a modem 1670 coupled, via a transceiver 1650, to an antenna 1652.

The device 1600 may include a display 1628 coupled to a display controller 1626. One or more speakers 1692, the microphone(s) 1694 may be coupled to the CODEC 1634. The CODEC 1634 may include a digital-to-analog converter (DAC) 1602, an analog-to-digital converter (ADC) 1604, or both. In a particular implementation, the CODEC 1634 may receive analog signals from the microphone(s) 1694, convert the analog signals to digital signals using the ADC 1604, and provide the digital signals to the speech and music codec 1608. The speech and music codec 1608 may process the digital signals, and the digital signals may further be processed by the ROI engine 1680. In a particular implementation, the speech and music codec 1608 may provide digital signals to the CODEC 1634. The CODEC 1634 may convert the digital signals to analog signals using the DAC 1602 and may provide the analog signals to the speaker(s) 1692.

In a particular implementation, the device 1600 may be included in a system-in-package or system-on-chip device 1622. In a particular implementation, the memory 1686, the processor 1606, the processor(s) 1610, the display controller 1626, the CODEC 1634, and the modem 1670 are included in the system-in-package or system-on-chip device 1622. In a particular implementation, an input device 1630, a power supply 1644, and a camera 1645 are coupled to the system-in-package or the system-on-chip device 1622. For example, the input device 1630 and the camera 1645 may include or correspond to the input device 114 and the image sensor 112, respectively. In some examples, the input device 1630 may include or be associated with the display device 116 or the display 1628. Moreover, in a particular implementation, as illustrated in FIG. 16, the display 1628, the input device 1630, the speaker(s) 1692, the microphone(s) 1694, the antenna 1652, the power supply 1644, and the camera 1645 are external to the system-in-package or the system-on-chip device 1622. In a particular implementation, each of the display 1628, the input device 1630, the speaker(s) 1692, the microphone(s) 1694, the antenna 1652, the power supply 1644, and the camera 1645 may be coupled to a component of the system-in-package or the system-on-chip device 1622, such as an interface or a controller.

The device 1600 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining image data representing an image. For example, the means for obtaining the image data can include the image sensor 112, the ROI engine 124, the model input generator 120, the processor 108, the device 102, the multimodal ROI detector and packer 202, the low-resolution global context image extractor 208, the components 200, the integrated circuit 800, the mobile device 900, the headset 1000, the wearable electronic device 1100, the voice-controlled speaker system 1200, the camera device 1300, the vehicle 1400, the processor 1606, the processor(s) 1610, the system-in-package or the system-on-chip device 1622, the device 1600, other circuitry configured to obtain image data, or a combination thereof.

The apparatus also includes means for obtaining data representing multiple regions of interest (ROIs) within the image, the multiple ROIs including one or more ROIs that include text. For example, the means for obtaining data representing multiple regions of interest (ROIs) within the image can include the sensor 110, the image sensor 112, the input device 114, the model input generator 120, the ROI detector 122, the ROI engine 124, the processor 108, the device 102, the multimodal ROI detector and packer 202, the components 200, the integrated circuit 800, the mobile device 900, the headset 1000, the wearable electronic device 1100, the voice-controlled speaker system 1200, the camera device 1300, the vehicle 1400, the processor 1606, the processor(s) 1610, the system-in-package or the system-on-chip device 1622, the device 1600, other circuitry configured to obtain data representing multiple regions of interest (ROIs) within the image, or a combination thereof.

The apparatus also includes means for arranging image representations of the ROIs into a single canvas image. For example, the means for arranging image representations of the ROIs into a single canvas image can include the ROI engine 124, the processor 108, the device 102, the multimodal ROI detector and packer 202, the components 200, the integrated circuit 800, the mobile device 900, the headset 1000, the wearable electronic device 1100, the voice-controlled speaker system 1200, the camera device 1300, the vehicle 1400, the processor 1606, the processor(s) 1610, the system-in-package or the system-on-chip device 1622, the device 1600, other circuitry configured to arrange image representations of the ROIs into a single canvas image, or a combination thereof.

The apparatus also includes means for inputting the canvas image into an image encoder of a multimodal model to obtain image tokens associated with cells of the canvas image. For example, the means for inputting the canvas image into an image encoder of a multimodal model to obtain image tokens associated with cells of the canvas image can include the model input generator 120, the multimodal model 126, the processor 108, the device 102, the multimodal ROIs detector and packer 202, the LMM 220, the components 200, the integrated circuit 800, the mobile device 900, the headset 1000, the wearable electronic device 1100, the voice-controlled speaker system 1200, the camera device 1300, the vehicle 1400, the processor 1606, the processor(s) 1610, the system-in-package or the system-on-chip device 1622, the device 1600, other circuitry configured to input the canvas image into an image encoder of a multimodal model to obtain image tokens associated with cells of the canvas image, or a combination thereof.

The apparatus also includes means for providing a first input to a large language model (LLM) of the multimodal model, the first input based on the image tokens, to generate a response output. For example, the means for providing a first input to the LLM of the multimodal model, the first input based on the image tokens, to generate a response output can include the mapper 144, the multimodal model 126, the processor 108, the device 102, the mapper 244, the components 200, the mapper 704, the integrated circuit 800, the ROI engine 820, the mobile device 900, the headset 1000, the wearable electronic device 1100, the voice-controlled speaker system 1200, the camera device 1300, the vehicle 1400, the ROI engine 1680, the processor 1606, the processor(s) 1610, the system-in-package or the system-on-chip device 1622, the device 1600, other circuitry configured to provide a first input to an LLM of the multimodal model, the first input based on the image tokens, to generate a response output, or a combination thereof.

In some implementations, a non-transitory computer-readable medium (e.g., a computer-readable storage device, such as the memory 106 or the memory 1686) includes instructions (e.g., the instructions 109 or the instructions 1656) that, when executed by one or more processors (e.g., the processor 108, the processor(s) 1610, or the processor 1606), cause the one or more processors to obtain image data (e.g., the image data 113) representing an image. The instructions, when executed by the one or more processors, also cause the one or more processors to obtain data representing multiple regions of interest (ROIs) within the image (e.g., the sensor data 111, the input data 115, the boundary data 134, or boundaries of text regions identified by the OCR module 204), the multiple ROIs including one or more ROIs that include text. The instructions, when executed by the one or more processors, also cause the one or more processors to arrange image representations (e.g., the image representations 412-418) of the ROIs (e.g., the ROIs 402-408) into a single canvas image (e.g., the multi-ROI canvas image 140, 240, 410, 510, 610, or 750). The instructions, when executed by the one or more processors, also cause the one or more processors to input the canvas image into an image encoder (e.g., the image encoder 142, 242, or 702) of a multimodal model (e.g., the multimodal model 126, the LMM 220, or the multimodal model 700) to obtain image tokens (e.g., the image tokens 243) associated with cells of the canvas image. The instructions, when executed by the one or more processors, also cause the one or more processors to provide a first input to a large language model (LLM) (e.g., the LLM 148, the LLM decoder 248, or the language model 708) of the multimodal model, the first input based on the image tokens, to generate a response output (e.g., the response output 138, 250, or 716).

Particular aspects of the disclosure are described below in sets of interrelated Examples:

According to Example 1, a device includes a memory configured to store model data associated with a multimodal model that includes an image encoder and a large language model (LLM), the image encoder configured to generate tokens that represent image features; and one or more processors coupled to the memory and configured to obtain image data representing an image; obtain data representing multiple regions of interest (ROIs) within the image, the multiple ROIs including one or more ROIs that include text; arrange image representations of the ROIs into a single canvas image; input the canvas image into the image encoder to obtain image tokens associated with cells of the canvas image; and provide a first input to the LLM, the first input based on the image tokens, to generate a response output that corresponds to a response to a query.

Example 2 includes the device of Example 1, wherein, to arrange the image representations of the multiple ROIs into the canvas image, the one or more processors are configured to obtain the image representations of the multiple ROIs based on patches of the image data corresponding to the multiple ROIs scaled according to a scaling factor, wherein the scaling factor is based on a total area of the multiple ROIs; and insert the image representations of the ROIs, sorted from largest to smallest, into the canvas image in a raster scan order with at least a threshold separation distance between each of the image representations.

Example 3 includes the device of Example 2, wherein the scaling factor is obtained based on a comparison of an occupancy factor to one or more occupancy thresholds, and wherein the occupancy factor corresponds to a ratio of the total area of the ROIs to an area of the canvas image.

Example 4 includes the device of Example 2 or Example 3, wherein, based on the total area of the ROIs exceeding the area of the canvas image, the one or more processors are configured to exclude one or more of the smallest of the ROIs from the canvas image so that the image representations of the remaining ROIs, separated by the threshold separation distance, fit within the canvas image.

Example 5 includes the device of Example 1, wherein, to arrange the image representations of the ROIs into the canvas image, the one or more processors are configured to divide the canvas image into a grid of equally-sized grid cells, wherein a number of the grid cells is selected to match or exceed a number of the ROIs; obtain the image representations of the ROIs based on patches of the image data corresponding to the ROIs, wherein each of the image representations is selectively scaled based on a grid cell size and a threshold separation distance; and insert each of the image representations into a respective grid cell with at least the threshold separation distance between each of the image representations.

Example 6 includes the device of Example 5, wherein the grid is a regular square grid having N rows and N columns, and wherein the one or more processors are configured to select N as a smallest integer value for which N² is greater than or equal to the number of the ROIs.

Example 7 includes the device of Example 5 or Example 6, wherein the one or more processors are configured to select a respective destination grid cell for the image representation of each particular ROI based on a similarity of a first location of the particular ROI within the image to a second location of the respective destination grid cell within the canvas image.

Example 8 includes the device of any of Examples 5 to 7, wherein the one or more processors are configured to select a respective destination grid cell for the image representation of each particular ROI based on distance between a center of each particular ROI within the image and a center of the destination grid cell; and based on two of the ROIs mapped to a single destination grid cell, allocate the larger of the two ROIs to the single destination grid cell and assign the smaller of the two ROIs to an adjacent grid cell.

Example 9 includes the device of Example 1, wherein, to arrange the image representations of the ROIs into the canvas image, the one or more processors are configured to obtain the image representations of the ROIs based on patches of the image data corresponding to the ROIs; and insert the image representations into the canvas image with at least a threshold separation distance between each of the image representations and according to a packing process that includes: insertion of the four largest image representations into respective corners of the canvas image, insertion of the next four largest image representations at the midpoint of each edge of the canvas image, and insertion of remaining image representations into a central rectangular region of the canvas image.

Example 10 includes the device of Example 9, wherein the one or more processors are configured to insert each of the remaining image representations, sorted from largest to smallest, into the central rectangular region in a raster scan order with at least a threshold separation distance between each of the remaining image representations.

Example 11 includes the device of Example 9 or Example 10, wherein, to insert the remaining image representations into the central rectangular region, the one or more processors are configured to divide the central rectangular region into a grid of equally sized grid cells, wherein a number of the grid cells is selected to match or exceed a number of the remaining image representations; and insert each of the remaining image representations into a respective grid cell, wherein the remaining image representations are selectively scaled to obtain at least the threshold separation distance between each of the remaining image representations in the grid.

Example 12 includes the device of any of Examples 1 to 11, wherein the one or more processors are configured to generate a pruned set of the image tokens corresponding to the canvas image by removal of one or more of the image tokens that do not correspond to any of the ROIs, and wherein the first input to the LLM is based on the pruned set of the image tokens.

Example 13 includes the device of Example 12, wherein the one or more processors are configured to identify one or more regions of the canvas image that, after arrangement of the image representations into the canvas image, do not correspond to any of the image representations; and identify a set of the cells of the canvas image that correspond to the one or more regions, wherein the one or more of the image tokens that are removed correspond to the identified set of the cells.

Example 14 includes the device of any of Examples 1 to 13, wherein the one or more processors are configured to identify the one or more ROIs that include text based on detection of text in the image.

Example 15 includes the device of any of Examples 1 to 14, wherein the one or more processors are configured to obtain multimodal ROI data corresponding to the ROIs within the image based on at least one of: speech based spatial grounding associated with input speech data; gaze tracking; image-based fingertip detection associated with the image data; image-based text detection associated with the image data; or a central region of the image.

Example 16 includes the device of any of Examples 1 to 15, wherein the one or more processors are configured to obtain multimodal ROI data corresponding to the ROIs within the image based on at least two of: speech based spatial grounding associated with input speech data; gaze tracking; image-based fingertip detection associated with the image data; image-based text detection associated with the image data; or a central region of the image.

Example 17 includes the device of any of Examples 1 to 16, wherein the one or more processors are configured to obtain data corresponding to a query; process the data corresponding to the query to generate question tokens; and provide the question tokens as a second input to the LLM, wherein the response output corresponds to a response to the query.

Example 18 includes the device of Example 17, wherein the one or more processors are configured to map the image tokens into a same token space as the question tokens to generate the first input to the LLM.

Example 19 includes the device of any of Examples 1 to 18 and further includes a modem coupled to the one or more processors and configured to receive the image data, the data representing the multiple ROIs, or a combination thereof.

Example 20 includes the device of any of Examples 1 to 19 and further includes one or more cameras coupled to the one or more processors and configured to generate the image data.

Example 21 includes the device of any of Examples 1 to 20 and further includes one or more microphones configured to generate audio data representing user speech, wherein the data representing the multiple ROIs includes the audio data.

Example 22 includes the device of any of Examples 1 to 20 and further includes one or more microphones configured to generate audio data representing user speech, wherein the data representing the multiple ROIs includes referring based on the audio data.

Example 23 includes the device of any of Examples 1 to 22 and further includes a user interface configured to generate text data based on user input, wherein the data representing the multiple ROIs includes the text data.

Example 24 includes the device of any of Examples 1 to 23, wherein the one or more processors are included in an integrated circuit.

Example 25 includes the device of any of Examples 1 to 23, wherein the one or more processors are integrated in at least one of a mobile phone, a tablet computer device, a wearable electronic device, an extended reality (XR) device, or a camera device, and wherein the mobile phone, the tablet computer device, the wearable electronic device, the XR device, or the camera device is configured to output the response output.

Example 26 includes the device of any of Examples 1 to 23, wherein the one or more processors are integrated in a vehicle that is configured to output the response output.

Example 27 includes the device of any of Examples 1 to 26, wherein the memory is configured to store a preference order of a plurality of ROI detection modalities, and wherein the one or more processors are configured to obtain a first indicator of a first ROI within the image, the first indicator corresponding to a first ROI detection modality of the plurality of ROI detection modalities; obtain a second indicator of a second ROI within the image, the second indicator corresponding to a second ROI detection modality of the plurality of ROI detection modalities, the second ROI detection modality different from the first ROI detection modality; and select one of the first ROI or the second ROI, based on the preference order, to process at the multimodal model.

Example 28 includes the device of Example 27, wherein the preference order is based on an amount of user specificity associated with each ROI modality of the plurality of ROI modalities.

Example 29 includes the device of any of Examples 1 to 28, wherein the one or more processors are further configured to: generate a global context image corresponding to a lower-resolution version of the image; and input the global context image into the image encoder to generate image tokens associated with the global context image, wherein the first input is further based on the image tokens associated with the global context image.

Example 30 includes the device of any of Examples 1 to 29, wherein the device is configured, based on the response output, to: i) control a machine such as a vehicle, a robot, an appliance, a mobile device, a camera; ii) control an actuator such as an electromechanical actuator, an electrohydraulic actuator, an electroactive polymer actuator; iii) control an active circuit component such as a voltage or current source, a transistor, an amplifier, an integrated circuit, a programmable device such as FPGA, a display device; iii) provide a notification to a user, such as a visual, auditory or haptic notification or combination thereof, iv) launch, close, pause or suspend an application on a computer; iv) launch, close, pause or suspend playback of AV media on a computer; or v) provide a control signal to initiate any of the above.

According to Example 31, a device includes a memory configured to store model data associated with a multimodal model that includes an image encoder and a large language model (LLM); and one or more processors coupled to the memory and configured to obtain image data representing an image; obtain data representing multiple regions of interest (ROIs) within the image; arrange image representations of the multiple ROIs into a single canvas image with at least a threshold separation distance between each of the image representations; input the canvas image into the image encoder to obtain image tokens associated with cells of the canvas image; and provide a first input to the LLM, the first input based on the image tokens, to generate a response output.

Example 32 includes the device of Example 31, wherein the threshold separation distance is based on a receptive field of the image encoder.

Example 33 includes the device of Example 31 or Example 32, wherein the multiple ROIs include one or more ROIs that include text.

Example 34 includes the device of Example 31, wherein, to arrange the image representations of the multiple ROIs into the canvas image, the one or more processors are configured to obtain the image representations of the multiple ROIs based on patches of the image data corresponding to the multiple ROIs scaled according to a scaling factor, wherein the scaling factor is based on a total area of the multiple ROIs; and insert the image representations of the ROIs, sorted from largest to smallest, into the canvas image in a raster scan order with at least a threshold separation distance between each of the image representations.

Example 35 includes the device of Example 34, wherein the scaling factor is obtained based on a comparison of an occupancy factor to one or more occupancy thresholds, and wherein the occupancy factor corresponds to a ratio of the total area of the ROIs to an area of the canvas image.

Example 36 includes the device of Example 34 or Example 35, wherein, based on the total area of the ROIs exceeding the area of the canvas image, the one or more processors are configured to exclude one or more of the smallest of the ROIs from the canvas image so that the image representations of the remaining ROIs, separated by the threshold separation distance, fit within the canvas image.

Example 37 includes the device of Example 31, wherein, to arrange the image representations of the ROIs into the canvas image, the one or more processors are configured to divide the canvas image into a grid of equally-sized grid cells, wherein a number of the grid cells is selected to match or exceed a number of the ROIs; obtain the image representations of the ROIs based on patches of the image data corresponding to the ROIs, wherein each of the image representations is selectively scaled based on a grid cell size and a threshold separation distance; and insert each of the image representations into a respective grid cell with at least the threshold separation distance between each of the image representations.

Example 38 includes the device of Example 37, wherein the grid is a regular square grid having N rows and N columns, and wherein the one or more processors are configured to select N as a smallest integer value for which N⁴ is greater than or equal to the number of the ROIs.

Example 39 includes the device of Example 37 or Example 38, wherein the one or more processors are configured to select a respective destination grid cell for the image representation of each particular ROI based on a similarity of a first location of the particular ROI within the image to a second location of the respective destination grid cell within the canvas image.

Example 40 includes the device of any of Examples 37 to 39, wherein the one or more processors are configured to select a respective destination grid cell for the image representation of each particular ROI based on distance between a center of each particular ROI within the image and a center of the destination grid cell; and based on two of the ROIs mapped to a single destination grid cell, allocate the larger of the two ROIs to the single destination grid cell and assign the smaller of the two ROIs to an adjacent grid cell.

Example 41 includes the device of Example 31, wherein, to arrange the image representations of the ROIs into the canvas image, the one or more processors are configured to obtain the image representations of the ROIs based on patches of the image data corresponding to the ROIs; and insert the image representations into the canvas image with at least a threshold separation distance between each of the image representations and according to a packing process that includes: insertion of the four largest image representations into respective corners of the canvas image, insertion of the next four largest image representations at the midpoint of each edge of the canvas image, and insertion of remaining image representations into a central rectangular region of the canvas image.

Example 42 includes the device of Example 41, wherein the one or more processors are configured to insert each of the remaining image representations, sorted from largest to smallest, into the central rectangular region in a raster scan order with at least a threshold separation distance between each of the remaining image representations.

Example 43 includes the device of Example 41 or Example 42, wherein, to insert the remaining image representations into the central rectangular region, the one or more processors are configured to divide the central rectangular region into a grid of equally sized grid cells, wherein a number of the grid cells is selected to match or exceed a number of the remaining image representations; and insert each of the remaining image representations into a respective grid cell, wherein the remaining image representations are selectively scaled to obtain at least the threshold separation distance between each of the remaining image representations in the grid.

Example 44 includes the device of any of Examples 31 to 43, wherein the one or more processors are configured to generate a pruned set of the image tokens corresponding to the canvas image by removal of one or more of the image tokens that do not correspond to any of the ROIs, and wherein the first input to the LLM is based on the pruned set of the image tokens.

Example 45 includes the device of Example 44, wherein the one or more processors are configured to identify one or more regions of the canvas image that, after arrangement of the image representations into the canvas image, do not correspond to any of the image representations; and identify a set of the cells of the canvas image that correspond to the one or more regions, wherein the one or more of the image tokens that are removed correspond to the identified set of the cells.

Example 46 includes the device of any of Examples 31 to 45, wherein the one or more processors are configured to identify the one or more ROIs that include text based on detection of text in the image.

Example 47 includes the device of any of Examples 31 to 46, wherein the one or more processors are configured to obtain multimodal ROI data corresponding to the ROIs within the image based on at least one of: speech based spatial grounding associated with input speech data; gaze tracking; image-based fingertip detection associated with the image data; image-based text detection associated with the image data; or a central region of the image.

Example 48 includes the device of any of Examples 31 to 47, wherein the one or more processors are configured to obtain data corresponding to a query; process the data corresponding to the query to generate question tokens; and provide the question tokens as a second input to the LLM, wherein the response output corresponds to a response to the query.

Example 49 includes the device of Example 48, wherein the one or more processors are configured to map the image tokens into a same token space as the question tokens to generate the first input to the LLM.

Example 50 includes the device of any of Examples 31 to 49 and further includes a modem coupled to the one or more processors and configured to receive the image data, the data representing the multiple ROIs, or a combination thereof.

Example 51 includes the device of any of Examples 31 to 50 and further includes one or more cameras coupled to the one or more processors and configured to generate the image data.

Example 52 includes the device of any of Examples 31 to 51 and further includes one or more microphones configured to generate audio data representing user speech, wherein the data representing the multiple ROIs includes the audio data.

Example 53 includes the device of any of Examples 31 to 52 and further includes a user interface configured to generate text data based on user input, wherein the data representing the multiple ROIs includes the text data.

Example 54 includes the device of any of Examples 31 to 53, wherein the one or more processors are included in an integrated circuit.

Example 55 includes the device of any of Examples 31 to 53, wherein the one or more processors are integrated in at least one of a mobile phone, a tablet computer device, a wearable electronic device, an extended reality (XR) device, or a camera device, and wherein the mobile phone, the tablet computer device, the wearable electronic device, the XR device, or the camera device is configured to output the response output.

Example 56 includes the device of any of Examples 31 to 53, wherein the one or more processors are integrated in a vehicle that is configured to output the response output.

Example 57 includes the device of any of Examples 31 to 56, wherein the memory is configured to store a preference order of a plurality of ROI detection modalities, and wherein the one or more processors are configured to obtain a first indicator of a first ROI within the image, the first indicator corresponding to a first ROI detection modality of the plurality of ROI detection modalities; obtain a second indicator of a second ROI within the image, the second indicator corresponding to a second ROI detection modality of the plurality of ROI detection modalities, the second ROI detection modality different from the first ROI detection modality; and select one of the first ROI or the second ROI, based on the preference order, to process at the multimodal model.

Example 58 includes the device of Example 57, wherein the preference order is based on an amount of user specificity associated with each ROI modality of the plurality of ROI modalities.

Example 59 includes the device of any of Examples 31 to 58, wherein the one or more processors are configured to obtain multimodal ROI data corresponding to the ROIs within the image based on at least two of: speech based spatial grounding associated with input speech data; gaze tracking; image-based fingertip detection associated with the image data; image-based text detection associated with the image data; or a central region of the image.

Example 60 includes the device of any of Examples 31 to 59, wherein the image encoder is configured to generate tokens that represent image features.

Example 61 includes the device of any of Examples 31 to 60, wherein the response output corresponds to a response to a query.

Example 62 includes the device of any of Examples 31 to 61, wherein the device is configured, based on the response output, to: i) control a machine such as a vehicle, a robot, an appliance, a mobile device, a camera; ii) control an actuator such as an electromechanical actuator, an electrohydraulic actuator, an electroactive polymer actuator; iii) control an active circuit component such as a voltage or current source, a transistor, an amplifier, an integrated circuit, a programmable device such as FPGA, a display device; iii) provide a notification to a user, such as a visual, auditory or haptic notification or combination thereof, iv) launch, close, pause or suspend an application on a computer; iv) launch, close, pause or suspend playback of AV media on a computer; or v) provide a control signal to initiate any of the above.

According to Example 63, a device includes a memory configured to store a preference order of a plurality of region of interest (ROI) detection modalities and model data associated with a multimodal model that includes an image encoder and a large language model (LLM); and one or more processors coupled to the memory and configured to obtain image data representing an image; obtain a first indicator of a first ROI within the image, the first indicator corresponding to a first ROI detection modality of the plurality of ROI detection modalities; obtain a second indicator of a second ROI within the image, the second indicator corresponding to a second ROI detection modality of the plurality of ROI detection modalities, the second ROI detection modality different from the first ROI detection modality; and select one of the first ROI or the second ROI, based on the preference order, to process at the multimodal model.

Example 64 includes the device of Example 63, wherein the one or more processors are configured to obtain data representing multiple regions of interest (ROIs) within the image, the multiple ROIs including one or more ROIs that include text; arrange image representations of the ROIs into a single canvas image; input the canvas image into the image encoder to obtain image tokens associated with cells of the canvas image; and provide a first input to the LLM, the first input based on the image tokens, to generate a response output.

Example 65 includes the device of Example 64, wherein, to arrange the image representations of the multiple ROIs into the canvas image, the one or more processors are configured to obtain the image representations of the multiple ROIs based on patches of the image data corresponding to the multiple ROIs scaled according to a scaling factor, wherein the scaling factor is based on a total area of the multiple ROIs; and insert the image representations of the ROIs, sorted from largest to smallest, into the canvas image in a raster scan order with at least a threshold separation distance between each of the image representations.

Example 66 includes the device of Example 65, wherein the scaling factor is obtained based on a comparison of an occupancy factor to one or more occupancy thresholds, and wherein the occupancy factor corresponds to a ratio of the total area of the ROIs to an area of the canvas image.

Example 67 includes the device of Example 65 or Example 66, wherein, based on the total area of the ROIs exceeding the area of the canvas image, the one or more processors are configured to exclude one or more of the smallest of the ROIs from the canvas image so that the image representations of the remaining ROIs, separated by the threshold separation distance, fit within the canvas image.

Example 68 includes the device of Example 64, wherein, to arrange the image representations of the ROIs into the canvas image, the one or more processors are configured to divide the canvas image into a grid of equally-sized grid cells, wherein a number of the grid cells is selected to match or exceed a number of the ROIs; obtain the image representations of the ROIs based on patches of the image data corresponding to the ROIs, wherein each of the image representations is selectively scaled based on a grid cell size and a threshold separation distance; and insert each of the image representations into a respective grid cell with at least the threshold separation distance between each of the image representations.

Example 69 includes the device of Example 68, wherein the grid is a regular square grid having N rows and N columns, and wherein the one or more processors are configured to select N as a smallest integer value for which N⁷ is greater than or equal to the number of the ROIs.

Example 70 includes the device of Example 68 or Example 69, wherein the one or more processors are configured to select a respective destination grid cell for the image representation of each particular ROI based on a similarity of a first location of the particular ROI within the image to a second location of the respective destination grid cell within the canvas image.

Example 71 includes the device of Example 64, wherein, to arrange the image representations of the ROIs into the canvas image, the one or more processors are configured to obtain the image representations of the ROIs based on patches of the image data corresponding to the ROIs; and insert the image representations into the canvas image with at least a threshold separation distance between each of the image representations and according to a packing process that includes: insertion of the four largest image representations into respective corners of the canvas image, insertion of the next four largest image representations at the midpoint of each edge of the canvas image, and insertion of remaining image representations into a central rectangular region of the canvas image.

Example 72 includes the device of Example 71, wherein the one or more processors are configured to insert each of the remaining image representations, sorted from largest to smallest, into the central rectangular region in a raster scan order with at least a threshold separation distance between each of the remaining image representations.

Example 73 includes the device of Example 71 or Example 72, wherein, to insert the remaining image representations into the central rectangular region, the one or more processors are configured to divide the central rectangular region into a grid of equally sized grid cells, wherein a number of the grid cells is selected to match or exceed a number of the remaining image representations; and insert each of the remaining image representations into a respective grid cell, wherein the remaining image representations are selectively scaled to obtain at least the threshold separation distance between each of the remaining image representations in the grid.

Example 74 includes the device of any of Examples 64 to 73, wherein the one or more processors are configured to generate a pruned set of the image tokens corresponding to the canvas image by removal of one or more of the image tokens that do not correspond to any of the ROIs, and wherein the first input to the LLM is based on the pruned set of the image tokens.

Example 75 includes the device of Example 74, wherein the one or more processors are configured to identify one or more regions of the canvas image that, after arrangement of the image representations into the canvas image, do not correspond to any of the image representations; and identify a set of the cells of the canvas image that correspond to the one or more regions, wherein the one or more of the image tokens that are removed correspond to the identified set of the cells.

Example 76 includes the device of any of Examples 64 to 75, wherein the one or more processors are configured to identify the one or more ROIs that include text based on detection of text in the image.

Example 77 includes the device of any of Examples 64 to 76, wherein the one or more processors are configured to obtain multimodal ROI data corresponding to the ROIs within the image based on at least one of: speech based spatial grounding associated with input speech data; gaze tracking; image-based fingertip detection associated with the image data; image-based text detection associated with the image data; or a central region of the image.

Example 78 includes the device of any of Examples 64 to 77, wherein the one or more processors are configured to obtain multimodal ROI data corresponding to the ROIs within the image based on at least two of: speech based spatial grounding associated with input speech data; gaze tracking; image-based fingertip detection associated with the image data; image-based text detection associated with the image data; or a central region of the image.

Example 79 includes the device of any of Examples 64 to 77, wherein the one or more processors are configured to obtain data corresponding to a query; process the data corresponding to the query to generate question tokens; and provide the question tokens as a second input to the LLM, wherein the response output corresponds to a response to the query.

Example 80 includes the device of Example 79, wherein the one or more processors are configured to map the image tokens into a same token space as the question tokens to generate the first input to the LLM.

Example 81 includes the device of any of Examples 63 to 80 and further includes a modem coupled to the one or more processors and configured to receive the image data.

Example 82 includes the device of any of Examples 63 to 81 and further includes one or more cameras coupled to the one or more processors and configured to generate the image data.

Example 83 includes the device of any of Examples 63 to 82 and further includes one or more microphones configured to generate audio data representing user speech, wherein the first ROI is based on the user speech.

Example 84 includes the device of any of Examples 63 to 83 and further includes a user interface configured to generate text data based on user input, wherein the first ROI is based on the text data.

Example 85 includes the device of any of Examples 63 to 84, wherein the one or more processors are included in an integrated circuit.

Example 86 includes the device of any of Examples 63 to 84, wherein the one or more processors are integrated in at least one of a mobile phone, a tablet computer device, a wearable electronic device, an extended reality (XR) device, or a camera device, and wherein the mobile phone, the tablet computer device, the wearable electronic device, the XR device, or the camera device is configured to output the response output.

Example 87 includes the device of any of Examples 63 to 84, wherein the one or more processors are integrated in a vehicle that is configured to output the response output.

Example 88 includes the device of any of Examples 63 to 87, wherein the preference order is based on an amount of user specificity associated with each ROI modality of the plurality of ROI modalities.

Example 89 includes the device of any of Examples 63 to 88, wherein the image encoder is configured to generate tokens that represent image features.

Example 90 includes the device of any of Examples 63 to 89, wherein the device is configured, based on an output of the multimodal model, to: i) control a machine such as a vehicle, a robot, an appliance, a mobile device, a camera; ii) control an actuator such as an electromechanical actuator, an electrohydraulic actuator, an electroactive polymer actuator; iii) control an active circuit component such as a voltage or current source, a transistor, an amplifier, an integrated circuit, a programmable device such as FPGA, a display device; iii) provide a notification to a user, such as a visual, auditory or haptic notification or combination thereof, iv) launch, close, pause or suspend an application on a computer; iv) launch, close, pause or suspend playback of AV media on a computer; or v) provide a control signal to initiate any of the above.

According to Example 91, a method includes obtaining image data representing an image; obtaining data representing multiple regions of interest (ROIs) within the image, the multiple ROIs including one or more ROIs that include text; arranging image representations of the ROIs into a single canvas image; inputting the canvas image into an image encoder of a multimodal model to obtain image tokens associated with cells of the canvas image; and providing a first input to a large language model (LLM) of the multimodal model, the first input based on the image tokens, to generate a response output.

Example 92 includes the method of Example 91, wherein arranging the image representations of the multiple ROIs into the canvas image includes: obtaining the image representations of the multiple ROIs based on patches of the image data corresponding to the multiple ROIs scaled according to a scaling factor, wherein the scaling factor is based on a total area of the multiple ROIs; and inserting the image representations of the ROIs, sorted from largest to smallest, into the canvas image in a raster scan order with at least a threshold separation distance between each of the image representations.

Example 93 includes the method of Example 92, wherein the scaling factor is obtained based on a comparison of an occupancy factor to one or more occupancy thresholds, and wherein the occupancy factor corresponds to a ratio of the total area of the ROIs to an area of the canvas image.

Example 94 includes the method of Example 92 or Example 93, and further includes, based on the total area of the ROIs exceeding the area of the canvas image, excluding one or more of the smallest of the ROIs from the canvas image so that the image representations of the remaining ROIs, separated by the threshold separation distance, fit within the canvas image.

Example 95 includes the method of Example 91, wherein arranging the image representations of the ROIs into the canvas image includes: dividing the canvas image into a grid of equally-sized grid cells, wherein a number of the grid cells is selected to match or exceed a number of the ROIs; obtaining the image representations of the ROIs based on patches of the image data corresponding to the ROIs, wherein each of the image representations is selectively scaled based on a grid cell size and a threshold separation distance; and inserting each of the image representations into a respective grid cell with at least the threshold separation distance between each of the image representations.

Example 96 includes the method of Example 95, wherein the grid is a regular square grid having N rows and N columns, the method further including selecting N as a smallest integer value for which N⁹ is greater than or equal to the number of the ROIs.

Example 97 includes the method of Example 95 or Example 96, and further includes selecting a respective destination grid cell for the image representation of each particular ROI based on a similarity of a first location of the particular ROI within the image to a second location of the respective destination grid cell within the canvas image.

Example 98 includes the method of any of Examples 95 to 97, wherein selecting a respective destination grid cell for the image representation of each particular ROI is based on distance between a center of each particular ROI within the image and a center of the destination grid cell and, based on two of the ROIs mapped to a single destination grid cell, allocating the larger of the two ROIs to the single destination grid cell and assigning the smaller of the two ROIs to an adjacent grid cell.

Example 99 includes the method of Example 91, wherein arranging the image representations of the ROIs into the canvas image includes: obtaining the image representations of the ROIs based on patches of the image data corresponding to the ROIs; and inserting the image representations into the canvas image with at least a threshold separation distance between each of the image representations and according to a packing process that includes: insertion of the four largest image representations into respective corners of the canvas image, insertion of the next four largest image representations at the midpoint of each edge of the canvas image, and insertion of remaining image representations into a central rectangular region of the canvas image.

Example 100 includes the method of Example 99, and further includes inserting each of the remaining image representations, sorted from largest to smallest, into the central rectangular region in a raster scan order with at least a threshold separation distance between each of the remaining image representations.

Example 101 includes the method of Example 99 or Example 100, and further includes, to insert the remaining image representations into the central rectangular region: dividing the central rectangular region into a grid of equally sized grid cells, wherein a number of the grid cells is selected to match or exceed a number of the remaining image representations; and inserting each of the remaining image representations into a respective grid cell, wherein the remaining image representations are selectively scaled to obtain at least the threshold separation distance between each of the remaining image representations in the grid.

Example 102 includes the method of any of Examples 91 to 101, and further includes generating a pruned set of the image tokens corresponding to the canvas image by removing one or more of the image tokens that do not correspond to any of the ROIs, and wherein the first input to the LLM is based on the pruned set of the image tokens.

Example 103 includes the method of Example 102, and further includes identifying one or more regions of the canvas image that, after arrangement of the image representations into the canvas image, do not correspond to any of the image representations; and identifying a set of the cells of the canvas image that correspond to the one or more regions, wherein the one or more of the image tokens that are removed correspond to the identified set of the cells.

Example 104 includes the method of any of Examples 91 to 103, and further includes identifying the one or more ROIs that include text based on detection of text in the image.

Example 105 includes the method of any of Examples 91 to 104, and further includes obtaining multimodal ROI data corresponding to the ROIs within the image based on at least one of: speech based spatial grounding associated with input speech data; gaze tracking; image-based fingertip detection associated with the image data; image-based text detection associated with the image data; or a central region of the image.

Example 106 includes the method of any of Examples 91 to 105, and further includes obtaining multimodal ROI data corresponding to the ROIs within the image based on at least two of: speech based spatial grounding associated with input speech data; gaze tracking; image-based fingertip detection associated with the image data; image-based text detection associated with the image data; or a central region of the image.

Example 107 includes the method of any of Examples 91 to 106, and further includes obtaining data corresponding to a query; processing the data corresponding to the query to generate question tokens; and providing the question tokens as a second input to the LLM, wherein the response output corresponds to a response to the query.

Example 108 includes the method of Example 107, further comprising mapping the image tokens into a same token space as the question tokens to generate the first input to the LLM.

Example 109 includes the method of any of Examples 91 to 108, and further includes receiving, via a modem, the image data, the data representing the multiple ROIs, or a combination thereof.

Example 110 includes the method of any of Examples 91 to 109, and further includes generating the image data at one or more cameras.

Example 111 includes the method of any of Examples 91 to 110, and further includes generating, at one or more microphones, audio data representing user speech, wherein the data representing the multiple ROIs includes the audio data.

Example 112 includes the method of any of Examples 91 to 110, and further includes generating, at one or more microphones, audio data representing user speech, wherein the data representing the multiple ROIs includes referring based on the audio data.

Example 113 includes the method of any of Examples 91 to 112, and further includes generating text data based on user input at a user interface, wherein the data representing the multiple ROIs includes the text data.

Example 114 includes the method of any of Examples 91 to 113, wherein the image encoder is configured to generate tokens that represent image features.

Example 115 includes the method of any of Examples 91 to 114, wherein the response output corresponds to a response to a query.

Example 116 includes the method of any of Examples 91 to 115, wherein the method further comprises, based on the response output: i) controlling a machine such as a vehicle, a robot, an appliance, a mobile device, a camera; ii) controlling an actuator such as an electromechanical actuator, an electrohydraulic actuator, an electroactive polymer actuator; iii) controlling an active circuit component such as a voltage or current source, a transistor, an amplifier, an integrated circuit, a programmable device such as FPGA, a display device; iii) providing a notification to a user, such as a visual, auditory or haptic notification or combination thereof, iv) launching, closing, pausing or suspending an application on a computer; iv) launching, closing, pausing or suspending playback of AV media on a computer; or v) providing a control signal to initiate any of the above.

According to Example 117, a device includes a memory configured to store instructions; and a processor configured to execute the instructions to perform the method of any of Examples 94 to 116.

According to Example 118, a non-transitory computer readable storage medium that stores instructions that, when executed by a processor, cause the processor to perform the method of any of Examples 94 to 116.

According to Example 119, an apparatus includes means for carrying out the method of any of Examples 94 to 116.

According to Example 120, a non-transitory computer readable storage medium stores instructions that, when executed by one or more processors, cause the one or more processors to obtain image data representing an image; obtain data representing multiple regions of interest (ROIs) within the image, the multiple ROIs including one or more ROIs that include text; arrange image representations of the ROIs into a single canvas image; input the canvas image into an image encoder of a multimodal model to obtain image tokens associated with cells of the canvas image; and provide a first input to a large language model (LLM) of the multimodal model, the first input based on the image tokens, to generate a response output.

According to Example 121, an apparatus includes means for obtaining image data representing an image; means for obtaining data representing multiple regions of interest (ROIs) within the image, the multiple ROIs including one or more ROIs that include text; means for arranging image representations of the ROIs into a single canvas image; means for inputting the canvas image into an image encoder of a multimodal model to obtain image tokens associated with cells of the canvas image; and means for providing a first input to a large language model (LLM) of the multimodal model, the first input based on the image tokens, to generate a response output.

Example 122 includes the apparatus of Example 121, wherein the image encoder is configured to generate tokens that represent image features.

Example 123 includes the apparatus of Example 121 or Example 122, wherein the response output corresponds to a response to a query.

According to Example 124, a method includes obtaining image data representing an image; obtaining data representing multiple regions of interest (ROIs) within the image; arranging image representations of the multiple ROIs into a single canvas image with at least a threshold separation distance between each of the image representations; inputting the canvas image into an image encoder of a multimodal model to obtain image tokens associated with cells of the canvas image; and providing a first input to a large language model (LLM) of the multimodal model, the first input based on the image tokens, to generate a response output.

Example 125 includes the method of Example 124, wherein the threshold separation distance is based on a receptive field of the image encoder.

Example 126 includes the method of Example 124 or Example 125, wherein the image encoder is configured to generate tokens that represent image features.

Example 127 includes the method of any of Examples 124 to 126, wherein the response output corresponds to a response to a query.

Example 128 includes the method of any of Examples 124 to 127, wherein the method further comprises, based on the response output: i) controlling a machine such as a vehicle, a robot, an appliance, a mobile device, a camera; ii) controlling an actuator such as an electromechanical actuator, an electrohydraulic actuator, an electroactive polymer actuator; iii) controlling an active circuit component such as a voltage or current source, a transistor, an amplifier, an integrated circuit, a programmable device such as FPGA, a display device; iii) providing a notification to a user, such as a visual, auditory or haptic notification or combination thereof, iv) launching, closing, pausing or suspending an application on a computer; iv) launching, closing, pausing or suspending playback of AV media on a computer; or v) providing a control signal to initiate any of the above.

According to Example 129, a device includes a memory configured to store instructions; and a processor configured to execute the instructions to perform the method of Example 127 or Example 128.

According to Example 130, a non-transitory computer readable storage medium that stores instructions that, when executed by a processor, cause the processor to perform the method of Example 127 or Example 128.

According to Example 131, an apparatus comprising means for carrying out the method of Example 127 or Example 128.

According to Example 132, a method includes obtaining image data representing an image; obtaining a first indicator of a first region of interest (ROI) within the image, the first indicator corresponding to a first ROI detection modality of a plurality of ROI detection modalities; obtaining a second indicator of a second ROI within the image, the second indicator corresponding to a second ROI detection modality of the plurality of ROI detection modalities, the second ROI detection modality different from the first ROI detection modality; and selecting one of the first ROI or the second ROI, based on a preference order, to process at a multimodal model that includes an image encoder and a large language model.

Example 133 includes the method of Example 132, wherein the preference order is based on an amount of user specificity associated with each ROI modality of the plurality of ROI modalities.

According to Example 134, a device includes a memory configured to store instructions; and a processor configured to execute the instructions to perform the method of Example 132 or Example 133.

According to Example 135, a non-transitory computer readable storage medium that stores instructions that, when executed by a processor, cause the processor to perform the method of Example 132 or Example 133.

According to Example 136, an apparatus comprising means for carrying out the method of Example 132 or Example 133.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store model data associated with a multimodal model that includes an image encoder and a large language model (LLM), the image encoder configured to generate tokens that represent image features; and
one or more processors coupled to the memory and configured to:
obtain image data representing an image;
obtain data representing multiple regions of interest (ROIs) within the image, the multiple ROIs including one or more ROIs that include text;
arrange image representations of the ROIs into a single canvas image;
input the canvas image into the image encoder to obtain image tokens associated with cells of the canvas image; and
provide a first input to the LLM, the first input based on the image tokens, to generate a response output that corresponds to a response to a query.

2. The device of claim 1, wherein, to arrange the image representations of the multiple ROIs into the canvas image, the one or more processors are configured to:
obtain the image representations of the multiple ROIs based on patches of the image data corresponding to the multiple ROIs scaled according to a scaling factor, wherein the scaling factor is based on a total area of the multiple ROIs; and
insert the image representations of the ROIs, sorted from largest to smallest, into the canvas image in a raster scan order with at least a threshold separation distance between each of the image representations.

3. The device of claim 2, wherein the scaling factor is obtained based on a comparison of an occupancy factor to one or more occupancy thresholds, and wherein the occupancy factor corresponds to a ratio of the total area of the ROIs to an area of the canvas image.

4. The device of claim 2, wherein, based on the total area of the ROIs exceeding the area of the canvas image, the one or more processors are configured to exclude one or more of the smallest of the ROIs from the canvas image so that the image representations of the remaining ROIs, separated by the threshold separation distance, fit within the canvas image.

5. The device of claim 1, wherein, to arrange the image representations of the ROIs into the canvas image, the one or more processors are configured to:
divide the canvas image into a grid of equally-sized grid cells, wherein a number of the grid cells is selected to match or exceed a number of the ROIs;
obtain the image representations of the ROIs based on patches of the image data corresponding to the ROIs, wherein each of the image representations is selectively scaled based on a grid cell size and a threshold separation distance; and
insert each of the image representations into a respective grid cell with at least the threshold separation distance between each of the image representations.

6. The device of claim 5, wherein the grid is a regular square grid having N rows and N columns, and wherein the one or more processors are configured to select N as a smallest integer value for which N² is greater than or equal to the number of the ROIs.

7. The device of claim 5, wherein the one or more processors are configured to:
select a respective destination grid cell for the image representation of each particular ROI based on distance between a center of each particular ROI within the image and a center of the destination grid cell; and
based on two of the ROIs mapped to a single destination grid cell, allocate the larger of the two ROIs to the single destination grid cell and assign the smaller of the two ROIs to an adjacent grid cell.

8. The device of claim 1, wherein, to arrange the image representations of the ROIs into the canvas image, the one or more processors are configured to:
obtain the image representations of the ROIs based on patches of the image data corresponding to the ROIs; and
insert the image representations into the canvas image with at least a threshold separation distance between each of the image representations and according to a packing process that includes:
insertion of the four largest image representations into respective corners of the canvas image,
insertion of the next four largest image representations at the midpoint of each edge of the canvas image, and
insertion of remaining image representations into a central rectangular region of the canvas image.

9. The device of claim 8, wherein the one or more processors are configured to insert each of the remaining image representations, sorted from largest to smallest, into the central rectangular region in a raster scan order with at least a threshold separation distance between each of the remaining image representations.

10. The device of claim 8, wherein, to insert the remaining image representations into the central rectangular region, the one or more processors are configured to:
divide the central rectangular region into a grid of equally sized grid cells, wherein a number of the grid cells is selected to match or exceed a number of the remaining image representations; and
insert each of the remaining image representations into a respective grid cell, wherein the remaining image representations are selectively scaled to obtain at least the threshold separation distance between each of the remaining image representations in the grid.

11. The device of claim 1, wherein the one or more processors are configured to generate a pruned set of the image tokens corresponding to the canvas image by removal of one or more of the image tokens that do not correspond to any of the ROIs, and wherein the first input to the LLM is based on the pruned set of the image tokens.

12. The device of claim 11, wherein the one or more processors are configured to:
identify one or more regions of the canvas image that, after arrangement of the image representations into the canvas image, do not correspond to any of the image representations; and
identify a set of the cells of the canvas image that correspond to the one or more regions,
wherein the one or more of the image tokens that are removed correspond to the identified set of the cells.

13. The device of claim 1, wherein the one or more processors are configured to identify the one or more ROIs that include text based on detection of text in the image.

14. The device of claim 1, wherein the one or more processors are configured to obtain multimodal ROI data corresponding to the ROIs within the image based on at least one of:
speech based spatial grounding associated with input speech data;
gaze tracking;
image-based fingertip detection associated with the image data;
image-based text detection associated with the image data; or
a central region of the image.

15. The device of claim 1, wherein the one or more processors are configured to:
obtain data corresponding to the query;
process the data corresponding to the query to generate question tokens; and
provide the question tokens as a second input to the LLM.

16. The device of claim 15, wherein the one or more processors are configured to map the image tokens into a same token space as the question tokens to generate the first input to the LLM.

17. The device of claim 1, further comprising a modem coupled to the one or more processors and configured to receive the image data, the data representing the multiple ROIs, or a combination thereof.

18. The device of claim 1, further comprising one or more cameras coupled to the one or more processors and configured to generate the image data.

19. The device of claim 1, further comprising one or more microphones configured to generate audio data representing user speech, wherein the data representing the multiple ROIs includes referring based on the audio data.

20. The device of claim 1, further comprising a user interface configured to generate text data based on user input, wherein the data representing the multiple ROIs includes the text data.

21. The device of claim 1, wherein the one or more processors are included in an integrated circuit.

22. The device of claim 1, wherein the one or more processors are integrated in at least one of a mobile phone, a tablet computer device, a wearable electronic device, an extended reality (XR) device, or a camera device, and wherein the mobile phone, the tablet computer device, the wearable electronic device, the XR device, or the camera device is configured to output the response output.

23. The device of claim 1, wherein the one or more processors are integrated in a vehicle that is configured to output the response output.

24. A device comprising:
a memory configured to store model data associated with a multimodal model that includes an image encoder and a large language model (LLM); and
one or more processors coupled to the memory and configured to:
obtain image data representing an image;
obtain data representing multiple regions of interest (ROIs) within the image;
arrange image representations of the multiple ROIs into a single canvas image with at least a threshold separation distance between each of the image representations;
input the canvas image into the image encoder to obtain image tokens associated with cells of the canvas image; and
provide a first input to the LLM, the first input based on the image tokens, to generate a response output.

25. The device of claim 24, wherein the threshold separation distance is based on a receptive field of the image encoder.

26. A device comprising:
a memory configured to store a preference order of a plurality of region of interest (ROI) detection modalities and model data associated with a multimodal model that includes an image encoder and a large language model; and
one or more processors coupled to the memory and configured to:
obtain image data representing an image;
obtain a first indicator of a first ROI within the image, the first indicator corresponding to a first ROI detection modality of the plurality of ROI detection modalities;
obtain a second indicator of a second ROI within the image, the second indicator corresponding to a second ROI detection modality of the plurality of ROI detection modalities, the second ROI detection modality different from the first ROI detection modality; and
select one of the first ROI or the second ROI, based on the preference order, to process at the multimodal model.

27. The device of claim 26, wherein the preference order is based on an amount of user specificity associated with each ROI modality of the plurality of ROI modalities.
